(19) United States
(12) Patent Application Publication
(10) Pub. No.: US 2026/0028462 A1
(43) Pub. Date: Jan. 29, 2026

(54) MICROFIBRILLATED LIGNOCELLULOSE FOAMS AND METHODS TO PREPARE THEM

(71) Applicants: THE UNIVERSITY OF BRITISH COLUMBIA, Vancouver (CA); YINKA DENE ECONOMIC DEVELOPMENT LIMITED PARTNERSHIP, Burns Lake (CA)

(72) Inventors: Feng JIANG, Vancouver (CA); Yeling ZHU, Vancouver (CA)

(21) Appl. No.: 18/992,260

(22) PCT Filed: Jun. 13, 2023
(86) PCT No.: PCT/CA2023/050815

§ 371 Date: Jan. 8, 2025

Related U.S. Application Data
(60) Provisional application No. 63/388,275, filed on Jul. 12, 2022.

(51) Int. Cl. C08J 9/28; C08J 9/36; C08K 5/527; C08L 97/02

(52) U.S. Cl. CPC C08J 9/28; C08J 9/365; C08K 5/527; C08L 97/02; C08J 2201/0504; C08J 2207/00; C08J 2397/02

(57) ABSTRACT

The present disclosure includes lignocellulosic foams which may be used, for example, in insulation as well as methods for their preparation. For example, the methods of preparing a foam may comprise: foaming an aqueous suspension comprising microfibrillated lignocellulose and a foaming agent to obtain a wet foam; and drying the wet foam to obtain the foam.

### CROSS-REFERENCE TO RELATED APPLICATIONS

The present application claims the benefit of priority from co-pending U.S. provisional application No. 63/388,275 filed on Jul. 12, 2022, the contents of which are incorporated herein by reference in their entirety.

### FIELD

The present disclosure relates to lignocellulosic foams, methods for their preparation and uses thereof, for example, in insulation.

### BACKGROUND

Climate changes have incurred more frequent and severe extreme weathers, particularly the extreme temperature events i.e., extreme heat and cold (Oudin Aström et al., 2013; Linares et al., 2020). To adapt to this new norm, one technological cornerstone is the implementation of building thermal insulation to mitigate the impact of outdoor temperature and improve indoor thermal comfort (Abu-Jdavil et al., 2019; Villasmil et al., 2019). The global building thermal insulation market, valued at 23 billion USD in 2021, is currently dominated by petrochemical-based polymers (expanded/extruded polystyrene, polyurethane, etc.) and inorganic fibers (glass fibers, mineral wools, etc.) with a combined market share of up to 95% (Global Market Insights, 2022). Unfortunately, heavily depending on these materials either inevitably intensifies the consumption of carbon-intensive, nonrenewable resources, or likely poses public health issues such as skin inflammation and inhalation-related hazards (Milby & Wolf, 1969: Sripaiboonkij et al., 2009). Therefore, developing reliable, high-performance thermal insulation products from renewable sources represents a great opportunity in fulfilling the rising demand for building thermal regulation in a sustainable way.

To provide thermal insulating function, lignocellulose can be made into foams where air or other type of gas is dispersed and enclosed in the scaffold of lignocellulosic fibers. This structure has been identified to restrict heat transfer, as the solid heat conduction and gas heat convection are hampered by the low solid fraction and structural tortuosity, respectively. Common approaches to fabricate such structure from lignocellulose include ice templating/freeze drying (Li et al., 2021: Zhu et al., 2022), solvent exchange/supercritical drying (Darpentigny et al., 2020), and bubble templating/air drying (Lohtander et al., 2022). Compared to the first two methods that are stuck at the stage of lab scale, bubble templating/air drying provides a greater opportunity for large-scale production of lignocellulosic foam, owing to the higher production efficiency, lower energy intensity, and less complicated operations. Typically, an aqueous suspension of lignocellulosic fibers is aerated using bubble templating to generate wet foam, where a foaming agent like Tween™-80 (Pöhler et al., 2017) or sodium dodecyl sulfate (SDS: Lohtander et al., 2022) can be used to hamper structure aging due to bubble collapse or coalescence. The ongoing water removal from the wet foam due to drainage and air drying drives the lignocellulosic fibers to aggregate and gradually assemble into porous, interconnected foam. However, though many endeavors have been made to develop air-dried foam from kraft or thermomechanical pulps (Pöhler et al., 2017: Jahangiri et al., 2014; He et al., 2019), mechanical properties of these foams are generally weak, showing low structural integrity, due to the lack of sufficient interaction among these fibers. Many chemical binders e.g., methylene diphenyl diisocyanate (MDI: Malekzadeh et al., 2021), citric acid (Ferreira et al., 2020), and borates (He et al., 2019) and/or crosslinkers e.g., polyacrylamide (Liu et al., 2017: Wu et al., 2022) and polyamidoamine epichlorohydrin (Liu et al., 2017) have been used to strengthen the structure. Yet, this practice may reduce the percentage of sustainable materials in the final foam, and many of the binders are difficult to handle due to toxicity and poor solubility in water. Progress achieved in the last few years demonstrated that nanoscale cellulose, particularly cellulose nanofibrils (CNF: Hafez & Tajvidi, 2021), could increase the viscosity (Xiang et al., 2019) and accumulate at the air-water interface of bubbles to suppress structural collapse (Cervin et al., 2015) and improve mechanical properties (Saint-Jalmes, 2006: Drenckhan & Saint-Jalmes, 2015). Hence, CNF has shown the capability of partially (Theng et al., 2015) or totally (Hafez & Tajvidi, 2021) substituting the chemical binders or polymer crosslinkers. However, since the production of CNF is expensive and requires the use of chemicals or energy-intensive mechanical process, a more sustainable and cost-effective approach is highly demanded.

Common chemical modifiers such as MDI (Jiang & Hsieh, 2017), silane (Qin et al., 2021), or acyl chloride (Chhajed et al., 2019) are unfavored as hydrophobic treatments from perspective of process complexity and reagent toxicity. Among all types of commercial natural waxes, palm (carnauba) wax gives the hardest texture (de Freitas et al., 2019) and has the highest melting temperature range (up to 83° C.) (Brazilian Ministry of Agriculture Livestock and Supply, 2004: Zhang et al., 2014). So far, palm wax has been mainly used for automobile waxing, furniture finishing, food glazing/acid regulator, cosmetic, and paper.

Global efforts to improve energy efficiency and reduce building carbon emission raise the demand of thermal insulation materials. The building thermal insulation represented a worldwide market of US$29.9 billion in 2021 and is projected to expand to US$42.5 billion by 2029, equivalent to a compound annual growth rate of 4.5% (Fortune Business Insights, 2022). However, up to 95% of the current market share is dominated by synthetic polymers, such as but not limited to polystyrene (Li et al., 2020), polyurethanes (Huang et al., 2019), and polyimides (Zhu et al., 2021), and inorganic fibers such as glass and minerals (Yi et al., 2022). Continuing the current reliance on these materials is expected to intensify the consumption of carbon-intensive nonrenewable resources and incur potential public health hazards such as those relating to skin and inhalation (Milby & Wolf, 1969: Sripaiboonkij et al., 2009). To tackle the stated changes and achieve the United Nations' sustainable development goals (SDGs), one strategy is to develop new types of insulative materials from nonhazardous, renewable resources (Adamczyk & Dylewski, 2017). For example, lignocellulose is a sustainable, widely available feedstock sourced from agricultural and forestry resources, including bulk wood and wood fibers (Zhu et al., 2022: Zhao et al., 2023), hemp (Beluns et al., 2021), crop by-products (Mathurā et al., 2019; Chen et al., 2021), and recycled paper (Hurtado et al., 2016), among others.

The method to prepare foams from lignocellulose is different from that used for synthetic polymers. The latter are blown into porous foams above their glass transition temperature and molded into designated geometries. By contrast, the lack of a solid-to-liquid transition in the case of lignocellulose demands other routes to produce foam materials. For instance, porous structures can be developed from lignocellulose by ice-templating via freeze-drying (Ren et al., 2022), solvent exchange via supercritical drying (Li et al., 2018), or air/oven drying (Chen et al., 2022). The former two approaches are relatively expensive and complicated (e.g., need for lyophilization or high-pressure operations) and/or involve organic solvents, which may, for example, discourage the scalable production of bulky building thermal insulation materials. To achieve mechanically robust foams, chemical binders such as borates (He et al., 2019), methylene diphenyl diisocyanate (Malekzadeh et al., 2021), and polyacrylamide (Wu et al., 2022) are commonly employed. However, most binders are associated with toxicity, reduce the sustainable composition in the final foam product, and prevent any efforts to recycle and reuse the materials at the end of service life.

Fire retardancy can be accomplished by integrating fire retardants. The latter include inorganics (Chen et al., 2022), phosphates (Jia et al., 2020), and borates (Zhang et al., 2023), which have been applied in chemically-bound forms (Zhu et al., 2022), as a supramolecular assembly (Ren et al., 2022), or by using physical entrapment (He et al., 2022). Clay minerals such as bentonite/montmorillonite (Chen et al., 2022), vermiculite (Rehman et al., 2021), and halloyosite (Hong et al., 2021) are examples of low-cost and non-toxic fire retardants (Yang et al., 2022). They serve as physical barrier to inhibit heat transfer, impede the contact of the substrate with air, and mitigate the generation and spread of flammable volatiles, which collectively promotes the composite's fire retardancy (Hou et al., 2021). The absence of nitrogen and phosphate elements allows clay to be free from eutrophication concerns, making it a more environmentally benign option among others. However, the interaction between clay and lignocellulose is generally weak, making it difficult to robustly integrate large quantity of clay into the host matrix. Reported strategies include the use of dissolved cellulose and chemical crosslinker to promote the binding with clay particles (Chen et al., 2022), which required massive use of the dissolving medium and limited the downstream chemical recycling/regeneration e.g., separation, purification, and concentration.

### SUMMARY

The present disclosure includes a method of preparing a foam, the method comprising: foaming an aqueous suspension comprising microfibrillated lignocellulose and a foaming agent to obtain a wet foam; and drying the wet foam to obtain the foam.

In an embodiment, the foaming agent comprises a surfactant. In another embodiment, the surfactant comprises an anionic surfactant, a non-ionic surfactant or combinations thereof. In an embodiment, the anionic surfactant comprises a sulfate group, a sulfonate group, a glutamate group or combinations thereof. In another embodiment, the surfactant is sodium dodecyl sulfate. In a further embodiment, the surfactant is C₁₄-C₁₆ alpha olefin sulfonate. In another embodiment, the surfactant is sodium cocoyl glutamate. In an embodiment, the non-ionic surfactant is a polysorbate, an alkylphenyl ether of polyethylene glycol, a poloxamer or combinations thereof. In another embodiment, the surfactant is sodium cocoyl glutamate, Tween™-20, Triton™ X100 or Pluronic™-127. In an embodiment, the dosage of the surfactant in the aqueous suspension is in the range of about 0.2 g/L to about 3.0 g/L.

In an embodiment, subsequent to drying, the method further comprises applying a hydrophobic coating to obtain the foam. In an embodiment, the hydrophobic coating comprises wax. In another embodiment, the wax comprises palm wax.

In an embodiment, the microfibrillated lignocellulose is obtained by a method comprising mechanical treatment of a lignocellulose source.

In an embodiment, the microfibrillated lignocellulose comprises microfibrillated softwood chemi-thermomechanical pulp (CTMP), microfibrillated refined softwood wood chips, microfibrillated sawdust or combinations thereof. In another embodiment, the microfibrillated lignocellulose comprises microfibrillated softwood chemi-thermomechanical pulp (CTMP). In an embodiment, the concentration of the microfibrillated lignocellulose in the aqueous suspension is about 0.1 wt % to about 10 wt %. In another embodiment, the concentration of the microfibrillated lignocellulose in the aqueous suspension is about 3 wt %.

In an embodiment, the drying comprises heating.

In an embodiment, the aqueous suspension further comprises a fire retardant. In an embodiment, the fire retardant comprises a clay. In another embodiment, the clay comprises kaolinite. In an embodiment, the fire retardant comprises a combination of polyethyleneimine (PEI) and phytic acid (PA).

In an embodiment, the foam does not comprise a binder.

The present disclosure also includes a method of preparing a recycled foam, the method comprising: preparing an aqueous dispersion comprising a foam prepared from a method of preparing a foam as described herein, wherein the foam does not comprise a binder; and drying the aqueous dispersion to prepare the recycled foam.

The present disclosure also includes a foam prepared by a method of preparing a foam of the present disclosure.

The present disclosure also includes a foam comprising microfibrillated lignocellulose. In an embodiment, the foam further comprises a hydrophobic coating. In another embodiment, the foam further comprises a fire retardant. In an embodiment, the fire retardant comprises clay. In another embodiment, the clay comprises kaolinite. In an embodiment, the fire retardant comprises a combination of polyethyleneimine (PEI) and phytic acid (PA). In an embodiment, the foam does not comprise a binder.

The present disclosure also includes a use of a foam of the present disclosure as described herein in insulation or packaging.

Other features and advantages of the present disclosure will become apparent from the following detailed description. It should be understood, however, that the detailed description and the specific examples, while indicating embodiments of the disclosure, are given by way of illustration only and the scope of the claims should not be limited by these embodiments, but should rather be given the broadest interpretation consistent with the description as a whole.

### BRIEF DESCRIPTION OF THE DRAWINGS

The embodiments of the disclosure will now be described in greater detail with reference to the attached drawings, in which:

FIG. 1 shows exemplary optical microscope images of chemi-thermomechanical pulp (CTMP), all captured with a polarizer except image in lower right. Scale bars show 100 μm (upper left image), 200 μm (upper right image) and 500 μm (lower images).

FIG. 2 shows exemplary optical microscope images of micro-fibrillated CTMP (MF-CTMP), all captured with a polarizer except image in lower right. Scale bars show 100 μm (upper left image), 200 μm (upper right image) and 500 μm (lower images).

FIG. 3 shows an exemplary transmission electron microscopy image of MF-CTMP (upper image): a schematic showing morphology variation of CTMP fibers before and after mild disc milling (middle image); and a schematic of an exemplary preparation of MF-CTMP foam via SDS foaming, drainage, and oven drying (lower schematic). Scale bar in upper image shows 1 μm.

FIG. 4 shows frequency distribution of fiber length (left plot) and fiber width (center plot); and water retention value (WRV) of CTMP and MF-CTMP (right plot).

FIG. 5 shows content of air entrapped in the wet fiber foam (left plot); and volume retention of wet fiber foam into dry foam during oven drying (right plot). Values sharing the same letter in the same group show no significant difference at α=0.05 (95% confidence interval).

FIG. 6 shows exemplary digital photos taken from top and side views of exemplary MF-CTMP foams prepared using specified SDS dosages, from left to right: 0, 0.6, and 1 g/L (left images) and the corresponding reflective OM photos showing top views (upper right images) and side views (lower right images). Scale bar in each of the right images shows 2 mm.

FIG. 7 shows exemplary digital camera photos of exemplary MF-CTMP foams prepared using specified SDS concentrations, from left to right: 0.2, 0.4, and 0.8 g/L (lower images), and the corresponding reflective OM photos (upper images). Scale bar in upper images shows 2 mm.

FIG. 8 is a plot showing ρₐ and porosity of exemplary MF-CTMP foams prepared using specified SDS dosages, from left to right: 0, 0.2, 0.4, 0.6, 0.8 and 1 g/L. Values sharing the same letter in the same group show no significant difference at α=0.05 (95% confidence interval).

FIG. 9 is a plot showing stress-strain curves of exemplary MF-CTMP foams prepared using various SDS dosages, inlet showing enlarged area between 0-5% strain.

FIG. 10 is a plot showing Young's modulus and specific modulus of exemplary MF-CTMP foams prepared using specified SDS dosages, from left to right: 0.2, 0.4, 0.6, 0.8 and 1 g/L. Values sharing the same letter in the same group show no significant difference at α=0.05 (95% confidence interval).

FIG. 11 shows exemplary scanning electron microscopy (SEM) images of the external surface of exemplary CTMP (upper images) and MF-CTMP (lower images) foams, prepared using 0.6 g/L SDS. Scale bars show 200 μm (left images) and 20 μm (right images).

FIG. 12 shows exemplary SEM images of the inside structure of exemplary CTMP (upper images) and MF-CTMP foams (lower images), prepared using 0.6 g/L SDS. Scale bars show 200 μm (left images) and 20 μm (right images).

FIG. 13 shows photographs of the break test of exemplary CTMP (left images) and MF-CTMP (right images) foam specimens, prepared using 0.6 g/L SDS.

FIG. 14 shows stress-strain curves, inlet showing enlarged area between 0-5% in strain (left plot): Young's modulus (center plot); and ultimate stress and material's toughness at strain of 0.8 (right plot) of exemplary CTMP and MF-CTMP foams, prepared using 0.6 g/L SDS. Values sharing the same letter in the same group show no significant difference at α=0.05 (95% confidence interval).

FIG. 15 shows exemplary SEM images of the external surface of MF-CTMP foams dip-coated with hexane solution of 10% (upper images) or 20% (lower images) palm wax. Scale bars show 200 μm (left images) and 20 μm (right images).

FIG. 16 shows exemplary digital camera photos of pristine CMTP foam (lower left images), and MF-CTMP foam prepared using 10% (lower center images) or 20% (lower right images) palm wax dip coating at an identical SDS concentration of 0.6 g/L, as well as the corresponding reflective OM photos (upper images). Scale bar in upper images shows 2 mm.

FIG. 17 is a plot showing apparent density ρₐ and porosity of palm wax coated MF-CTMP foams in comparison to uncoated MF-CTMP foam.

FIG. 18 shows exemplary SEM images of the interior of MF-CTMP foams dip-coated with hexane solution of 10% (upper images) and 20% (lower images) palm wax. Scale bars show 200 μm (left images) and 20 μm (right images).

FIG. 19 shows exemplary OM photos of water droplets on the exterior of MF-CTMP foams without wax coating (upper row), or dip coated with hexane solution of 10% (middle row) or 20% (lower row) palm wax. From left to right in upper row: images show 1 second before contact, 30 seconds after contact, and 60 seconds after contact. From left to right in other rows: images show contact, 30 seconds after contact, and 60 seconds after contact.

FIG. 20 is a plot showing contact angle of exemplary MF-CTMP foams dip-coated with hexane solution of 10% or 20% palm wax.

FIG. 21 shows exemplary OM photos of water droplets on the interior of MF-CTMP foams without wax coating (upper row), or dip coated with hexane solution of 10% (middle row) or 20% (lower row) palm wax. From left to right in upper row: images show 1 second before contact, 1 second after contact, and 5 seconds after contact. From left to right in other rows: images show contact, 30 seconds after contact, and 60 seconds after contact.

FIG. 22 is a plot showing contact angle of the interior of exemplary MF-CTMP foams dip-coated with hexane solution of 10% or 20% palm wax.

FIG. 23 shows photographs of a water resistance demonstration of exemplary uncoated (left) and 20% palm wax coated (right) MF-CTMP foams, with foam placed at an angle of 45° and water dyed blue to improve visibility.

FIG. 24 is a plot showing moisture uptake of exemplary foams without wax coating or coated using 10% or 20% wax in hexane solution.

FIG. 25 shows stress-strain curves of MF-CTMP foams dip coated with different amount of palm wax (abbreviated “PW”), inlet showing enlarged area between 0-5% in strain (left plot): Young's modulus (center plot); and ultimate stress and material's toughness at strain of 0.8 of exemplary MF-CTMP foams (right plot). Values sharing the same letter in the same group show no significant difference at α=0.05 (95% confidence interval).

FIG. 26 is a plot showing thermal conductivity of exemplary MF-CTMP foams, prepared with 0, 0.2, 0.4, 0.6, 0.8 or 1 g/L SDS in foaming, as well as an exemplary palm wax-coated foam, prepared with 0.6 g/L SDS.

FIG. 27 shows infrared photos of an exemplary MF-CTMP foam (SDS dosage of 0.6 g/L, coated with 20% palm wax solution) placed on a heating plate thermostatic at 70.0+0.5° C. at 0 min (upper left image), 10 min (upper center image), 50 min (upper right image), 90 min (lower left image) and 180 min (lower center image) and upper surface of the foam (lower right image).

FIG. 28 shows schematics of thermal regulation demonstration using MF-CTMP foams, palm wax-coated foam, and commercial glass fiber mat for the hot or cold scenarios. Experiment photos are provided in FIG. 29.

FIG. 29 shows photographs of, from left to right in top row: the “heat sink” used for high-accuracy temperature detection: the “heat sink” used to quantify the indoor temperature of the model bungalow: MF-CTMP foam and commercial GF mat used for the demonstration, both with thickness of 2.0 cm; and dry ice pellets placed in a stainless-steel pan used as the cold source: from left to right in middle row: IR camera used to quantify the outside temperature (at the center of the tested thermal insulator's upper surface); demonstration of exemplary MF-CTMP foam in the hot scenario; demonstration of exemplary palm wax coated foam in the hot scenario; and demonstration of comparative commercial glass fiber mat in the hot scenario; and from left to right in lower row: thermal-sensors used to quantify both the outside and indoor temperatures: demonstration of exemplary MF-CTMP foam in the cold scenario: demonstration of exemplary palm wax coated foam in the cold scenario; and demonstration of comparative commercial GF mat in the cold scenario.

FIG. 30 shows a plot showing the indoor and outdoor temperatures of the model bungalow in an exemplary heating scenario. (left); and a plot showing the indoor and outdoor temperatures of the model bungalow in an exemplary cooling scenario (right). The thickness of all thermal insulators was kept a constant of 2 cm.

FIG. 31 shows a schematic (left) of an exemplary preparation of lightweight, binder-free lignocellulosic foam via mild mechanical treatment of wood fibers to obtain hyperbranched wood fibers followed by foaming, air drying and coating with natural wax: a photograph of an exemplary lightweight, binder-free lignocellulosic foam (upper right) as well as exemplary photographs showing, from left to right: the hydrophobicity, high strength and thermal insulating properties of such lignocellulosic foams (lower right photographs).

FIG. 32 shows exemplary photographs of wood chips (left image), refined wood fibers (R-fiber: center image), and 3 wt % micro-fibrillated wood fiber (M-fiber) slurry (right image). Ruler to show scale in left and center images. Scale bar in right image shows 1 cm.

FIG. 33 shows exemplary polarized OM images of R-fiber (left and center images) and an exemplary OM image of R-fiber (right image). Scale bars show 500 μm.

FIG. 34 shows exemplary polarized OM images of M-fiber (left and center images) and an exemplary OM image of M-fiber (right image). Scale bars show 500 μm.

FIG. 35 shows plots of the frequency distribution of fiber length (histogram's interval: 50 μm) (left) and fiber width (interval: 2 μm) (right) for exemplary R- and M-fibers.

FIG. 36 shows an exemplary photograph of 0.25% aqueous suspension of R- and M-fiber (left and right, respectively), 10 min after vortexing.

FIG. 37 is a plot showing WRV of exemplary R- and M-fibers.

FIG. 38 shows exemplary SEM images (plane view) of R-fiber foam. Scale bars show 50 μm (left image) and 100 μm (center and right images).

FIG. 39 shows exemplary SEM images (plane view) of M-fiber foam. Scale bars show 50 μm (left image) and 100 μm (center and right images).

FIG. 40 shows an exemplary photograph of kaolinite (left) and a plot showing its particle size distribution (right).

FIG. 41 is a plot showing clay retention in wood fiber foams, made from exemplary R- or M-fiber with given initial clay loading.

FIG. 42 shows exemplary SEM images (plane view) of R-fiber foam with kaolinite clay (clay/fiber ratio in initial slurry=2). Scale bars show 50 μm (upper images) and 100 μm (lower images).

FIG. 43 shows exemplary SEM images (plane view) of M-fiber foam with kaolinite clay (clay/fiber ratio in initial slurry=2). Scale bars show 50 μm (upper images) and 100 μm (lower images).

FIG. 44 is a plot showing stress-strain curves (inset shows enlarged area of 0-0.1 compression strain range) of exemplary wood fiber foams, with and without clay.

FIG. 45 is a plot showing Young's modulus of exemplary wood fiber foams, with and without clay.

FIG. 46 shows plots of apparent density (upper left): Young's modulus (upper right): thermal conductivity (lower left) and LOI (lower right) for groups of Table 2.

FIG. 47 shows main effects plot of signal/noise ratio for exemplary lignocellulose/clay composite foams' apparent density (upper left), Young's modulus (upper right), thermal conductivity (lower left), and LOI (lower right), and their dependence on fiber concentration, surfactant amount, and clay dosage, each at three levels of variation.

FIG. 48 is a photograph of exemplary lignocellulose/clay composite foams of different thicknesses.

FIG. 49 shows a schematic (upper left), an exemplary photograph (upper right) and a plot (lower) relating to thermal insulation demonstrations of commercial EPS foam, exemplary wood fiber foam (no clay), and exemplary lignocellulose/clay composite foam.

FIG. 50 shows photographs of commercial EPS (left image): exemplary clay/fiber foam (center image); and both foams (right image) placed on a bench.

FIG. 51 shows photographs of fire retardancy demonstrations of commercial EPS foam (upper row), exemplary wood fiber foam (no clay: middle row), and exemplary lignocellulose/clay composite foam (lower row).

FIG. 52 shows an exemplary photograph of melting and dripping of EPS.

FIG. 53 shows exemplary photographs of exterior (left image) and interior (right image) of the lignocellulose/clay composite foam's charred region.

FIG. 54 is a schematic showing an example of recycling the lignocellulose/clay composite foam from used ones.

FIG. 55 shows plots showing characteristics/performance retention of apparent density (upper left), Young's modulus (upper right), thermal conductivity (lower left), and LOI (lower right), of exemplary lignocellulose/clay composite foam after 1, 2, or 3 recycling cycles.

FIG. 56 is a schematic showing an exemplary production of lignocellulose/clay composite foam from wood and mineral resources, its recycling and end-of-life disposal.

FIG. 57 is a plot showing Young's modulus as a function of overall density for foams prepared from exemplary surfactants.

FIG. 58 is a plot showing stress at strain as a function of overall density for foams prepared from exemplary surfactants.

FIG. 59 shows photographs at day one (upper image), after one month (middle image) and after four months (lower image) of exemplary foams prepared from the surfactants of Example 3 (upper foams and lower left foam in all images) in comparison to exemplary plastic foams (lower center and lower right foam in each image).

FIG. 60 shows exemplary SEM images of MF-CTMP/PEI/PA composite. Scale bars show 500 μm (left image) and 50 μm (right images).

FIG. 61 is a plot showing compression stress for MF-CTMP/PEI/PA composites having various amounts of PEI and PA in comparison to MF-CTMP foam (SA-0).

FIG. 62 is a plot showing Young's modulus (left axis and left columns) and specific modulus (right axis and right columns) for MF-CTMP/PEI/PA composites having various amounts of PEI and PA in comparison to MF-CTMP foam (SA-0).

FIG. 63 is a plot showing LOI for MF-CTMP/PEI/PA composites having various amounts of PEI and PA in comparison to MF-CTMP foam (SA-0).

FIG. 64 is a plot showing thermal conductivity for MF-CTMP/PEI/PA composites having various amounts of PEI and PA in comparison to MF-CTMP foam (SA-0).

FIG. 65 is a plot showing compression stress for pure MF-sawdust foams having various dosages of SCG in comparison to MF-sawdust board prepared without SCG.

FIG. 66 is a plot showing density (left axis and left columns) and specific modulus (right axis and right columns) for pure MF-sawdust foams having various dosages of SCG in comparison to MF-sawdust board prepared without SCG.

FIG. 67 shows plots showing compression (left plot) and three-point bending (right plot) results for foams prepared from varying amounts of MF-CTMP and MF-sawdust.

### DETAILED DESCRIPTION

### I. Definitions

Unless otherwise indicated, the definitions and embodiments described in this and other sections are intended to be applicable to all embodiments and aspects of the disclosure herein described for which they would be understood to be suitable by a person skilled in the art.

As used herein, the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process/method steps. As used herein, the word “consisting” and its derivatives, are intended to be close ended terms that specify the presence of stated features, elements, components, groups, integers, and/or steps, and also exclude the presence of other unstated features, elements, components, groups, integers and/or steps. The term “consisting essentially of” and any form thereof, as used herein, is intended to specify the presence of the stated features, elements, components, groups, integers, and/or steps as well as those that do not materially affect the basic and novel characteristic(s) of these features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

As used in this disclosure, the singular forms “a”, “an” and “the” include plural references unless the content clearly dictates otherwise.

The term “and/or” as used herein means that the listed items are present, or used, individually or in combination. In effect, this term means that “at least one of” or “one or more” of the listed items is used or present.

The term “suitable” as used herein means that the selection of the particular compound, material and/or conditions would depend on the specific synthetic manipulation to be performed, and/or the identity of the compound(s) to be transformed, but the selection would be well within the skill of a person skilled in the art. All method steps described herein are to be conducted under conditions sufficient to provide the product shown.

### II. Methods. Foams and Uses Thereof

A mild mechanical pretreatment strategy which can be used, for example, for scalable fabrication of low-cost, self-strengthening lignocellulosic thermal insulation foams without external binder use is described herein. Softwood chemi-thermomechanical pulp (CTMP), used as the model lignocellulose feedstock, was subject to mechanical micro-fibrillation using disc milling. Refined softwood wood chips and sawdust were also used as exemplary woody material feedstocks. Palm wax was employed to coat the surface of pristine foam, to enhance water/moisture resistance in a green and sustainable way. The thermal insulation performance of the treated foam was quantified through modified transient plane source (MTPS) method and demonstrated using a custom-built building model, in comparison with a commercial GF thermal insulation mat. Taken together, this study provides an example of a scalable strategy for facile production of natural wax coated, highly thermal insulating, and mechanically robust foam from lignocellulose with minimum petrochemical use.

Accordingly, the present disclosure includes a method of preparing a foam, the method comprising:
foaming a suspension, e.g., an aqueous suspension comprising microfibrillated lignocellulose and a foaming agent to obtain a wet foam; and
drying the wet foam to obtain the foam.

The foaming of the aqueous suspension comprising microfibrillated lignocellulose and the foaming agent to obtain a wet foam can comprise any suitable method and/or means, the selection of which can be readily made by a person skilled in the art having regard to the present disclosure. For example, the foaming agent can be any suitable foaming agent or combination thereof. The term “foaming agent” as used herein includes any agent or combination thereof capable of facilitating the formation of foam. For example, a foaming agent may be useful in bubble templating, for example, to at least partially decrease structure aging due to bubble collapse and/or coalescence. The term “foaming agent” as used herein may include any suitable blowing agent, amphiphilic compound (e.g., a surfactant, a suitable water-soluble polymeric foaming agent such as polyvinyl alcohol, an amino acid-based foaming agent such as gelatin or suitable derivatives thereof or combinations thereof) or combinations thereof.

In an embodiment, the foaming agent comprises, consists essentially of or consists of a surfactant. The term “surfactant” as used herein refers to a substance capable of lowering the surface tension between, for example, two liquids, a liquid and a solid and/or a liquid and a gas. For example, a surfactant may reduce the work required to create a foam and/or increase its colloidal stability by inhibiting coalescence of bubbles. Surfactants are compounds that typically comprise one or more hydrophilic head groups and one or more hydrophobic tail groups. The hydrophilic head groups may be negatively charged, in the case of an anionic surfactant, positively charged in the case of a cationic surfactant, have no charge in the case of a non-ionic surfactant, or have two oppositely charged groups in the case of an amphoteric surfactant. The surfactant can be any suitable surfactant or combination thereof.

In an embodiment, the foaming agent comprises, consists essentially of or consists of an anionic surfactant. The anionic surfactant can be any suitable anionic surfactant or combination thereof. Suitable anionic groups may include, for example, a sulfate, a sulfonate, phosphate or a glutamate. Accordingly, in an embodiment, the anionic surfactant comprises, consists essentially of or consists of an anionic surfactant having a sulfate group, a sulfonate group, a glutamate group or combinations thereof. Suitable hydrophobic tail groups may include, for example, a hydrocarbon chain, optionally including one or more sites of branching, unsaturation and/or heteroatoms (e.g., oxygen such as in a tail group comprising a polyether) or lignin (e.g., in the case of lignosulfonate surfactants). In embodiment, the hydrophobic tail group comprises a linear hydrocarbon. In an embodiment, the linear hydrocarbon has from 8 to 18 carbon atoms, e.g., 12 carbon atoms. In another embodiment, the hydrophobic tail group comprises a mixture of olefinic hydrocarbons having from 14 to 16 carbon atoms. In a further embodiment, the hydrophobic tail group comprises lignin. Anionic surfactants also comprise a suitable positively charged countercation. In an embodiment, the positively charged countercation comprises, consists essentially of, or consists of sodium ion. In an embodiment, the surfactant comprises, consists essentially of, or consists of sodium dodecyl sulfate. In another embodiment, the surfactant comprises, consists essentially of or consists of C₁₄-C₁₆ alpha olefin sulfonate.

In an embodiment, the foaming agent comprises, consists essentially of or consists of a non-ionic surfactant. The non-ionic surfactant can be any suitable non-ionic surfactant or combination thereof. In an embodiment, the non-ionic surfactant comprises a polysorbate, an alkylphenyl ether of polyethylene glycol, a poloxamer or combinations thereof.

The term “polysorbate” as used herein refers to a non-ionic surfactant derived from ethoxylated sorbitan esterified with a fatty acid and includes combinations of such surfactants comprising a mixture of fatty acids. In an embodiment, the polysorbate is polysorbate 20. It will be appreciated by a person skilled in the art that commercial sources of such a polysorbate may be in the form of combinations of compounds having different chain lengths of the fatty acid. For example, a commercial source of polysorbate 20 is Tween™ 20 (polyethylene glycol sorbitan monolaurate) which may comprise a lauric acid ester of ethoxylated sorbitan in an amount greater than or equal to about 40%, with the balance primarily comprising a myristic acid ester, a palmitic acid ester and a stearic acid ester of ethoxylated sorbitan.

The term “alkylphenyl ether of polyethylene glycol” as used herein refers to a non-ionic surfactant made up of an oligo (ethylene glycol) group bound to an alkylated phenyl group via an ether linkage. It will be appreciated by a person skilled in the art that commercial sources of alkylphenyl ethers of polyethylene glycols may be in the form of combinations of compounds having different lengths of oligo (ethylene glycol) groups. For example, Triton™ X-100 is a combination of compounds of Formula (I) wherein x is 9-10. Accordingly, in an embodiment, the alkylphenyl ether of polyethylene glycol is a combination of compounds of the Formula (I):

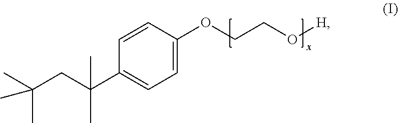

wherein x is 9-10.

The term “poloxamer” as used herein refers to a class of amphoteric tri-block copolymers that are of the structure: polyethylene glycol-b-polypropylene glycol-b-polyethylene glycol. In an embodiment, the poloxamer is poloxamer 407 (e.g., Pluronic™ 127), wherein the approximate lengths of the two polyethylene glycol blocks are 101 repeat units and the approximate length of the polypropylene glycol block is 56 repeat units.

In an embodiment, the foaming agent comprises, consists essentially of or consists of a cationic surfactant. The cationic surfactant can be any suitable cationic surfactant or combination thereof. In an embodiment, the cationic surfactant comprises a quaternary ammonium head group, e.g., a trialkylammonium head group. Cationic surfactants also comprise a suitable negatively charged counteranion. In an embodiment, the negatively charged counteranion comprises, consists essentially of, or consists of bromide ion. In an embodiment, the cationic surfactant comprises cetyltrimethylammonium bromide.

In an embodiment, the foaming agent comprises, consists essentially of or consists of an amphoteric surfactant. The amphoteric surfactant can be any suitable amphoteric surfactant or combination thereof. In an embodiment, the amphoteric surfactant comprises a suitable betaine. The term “betaine” as used herein refers to a neutral surfactant comprising a suitable positively charged cationic group bearing no hydrogen atom (e.g., a quaternary ammonium group) and a suitable negatively charged group (e.g., a carboxylate group). In an embodiment, the amphoteric surfactant comprises C₁₂₋₁₅ alkyl dimethyl betaine.

In an embodiment, the surfactant comprises, consists essentially of or consists of an anionic surfactant, a non-ionic surfactant or combinations thereof.

In an embodiment, the surfactant has high biodegradability and/or low toxicity. In another embodiment, the surfactant has high biodegradability and low toxicity. A person skilled in the art would readily be able to determine a suitable surfactant having high biodegradability and/or low toxicity. For example, there exist publicly available databases (e.g., the “Safer Chemical Ingredients List” and the “Detergents Ingredients Database”) which include such surfactants. In an embodiment, the surfactant having high biodegradability and/or low toxicity comprises, consists essentially of or consists of sodium cocoyl glutamate, a suitable polysorbate (e.g., Tween™-20), a suitable alkylphenyl ether of polyethylene glycol (e.g., Triton™ X100) or suitable poloxamer (e.g., Pluronic™-127). In another embodiment, the surfactant comprises, consists essentially of or consists of sodium cocoyl glutamate.

The dosage of the foaming agent in the aqueous suspension is any suitable dosage, the selection of which can be readily made by a person skilled in the art having regard to the present disclosure. For example, a person skilled in the art would readily appreciate that the dosage may depend, for example, on the identity of the foaming agent (e.g., greater amounts of a cationic surfactant may be required in comparison to a non-ionic or anionic surfactant in view of the negative charge of the microfibrillated lignocellulose) and/or the presence and/or identity of optional additional components (e.g., a fire retardant) in the aqueous suspension. In an embodiment, the dosage of the foaming agent in the aqueous suspension is in the range of about 0.05 g/L to about 10 g/L. In another embodiment, the dosage of the foaming agent in the aqueous suspension is in the range of about 0.2 g/L to about 3.0 g/L. In another embodiment, the dosage of the foaming agent in the aqueous suspension is in the range of about 0.2 g/L to about 0.8 g/L, about 0.6 g/L or about 0.2 g/L. In another embodiment, (e.g., wherein the aqueous suspension comprises a fire retardant), the dosage of the foaming agent in the aqueous suspension is in the range of about 0.5 g/L to about 2.5 g/L, about 1.5 g/L or about 2.0 g/L.

In an embodiment, subsequent to drying, the method further comprises applying a hydrophobic coating to obtain the foam. In some embodiments, the hydrophobic coating comprises wax. However, the hydrophobic coating can be any suitable hydrophobic coating, the selection of which can be made by a person skilled in the art. In an embodiment, the applying the hydrophobic coating comprises applying wax, a plant-distilled oil, rosin, an alkyl ketene dimer or combinations thereof, and the hydrophobic coating comprises, consists essentially of or consists of wax, a plant-distilled oil, rosin, a reaction product of hydroxyl groups comprised in the foam with the alkyl ketene dimer or combinations thereof. In an embodiment, the hydrophobic coating comprises, consists essentially of or consists of wax. The wax can be any suitable wax or combination thereof, the selection of which can be made by a person skilled in the art. For example, it would be appreciated by a person skilled in the art that the wax desirably has a melting temperature in a range suitable for the intended use of the foam, and could select a suitable wax or combination thereof accordingly. In an embodiment, the wax comprises paraffin, a natural wax (such as but not limited to palm wax, soybean wax, beeswax or combinations thereof) or combinations thereof. In an embodiment, the wax comprises, consists essentially of or consists of palm wax. The plant-distilled oil can be any suitable plant-distilled oil or combination thereof, the selection of which can be made by a person skilled in the art. In an embodiment, the plant-distilled oil comprises, consists essentially of or consists of tung oil, pine oil, limonene, linseed oil or combinations thereof. The term “alkyl ketene dimer” as used herein refers to a class of compounds based on the four-membered ring system of oxetan-2-one, which comprises a C₁₂₋₁₆alkyl group attached in the 3-position of the oxetane ring and a C₁₃₋₁₇ alkylidene group attached in the 4-position of the oxetane ring. The alkyl ketene dimer can be any suitable alkyl ketene dimer or combination thereof, the selection of which can be made by a person skilled in the art. The application of the hydrophobic coating can comprise any suitable method and/or means, the selection of which can be made by a person skilled in the art. For example, the skilled person would appreciate that a suitable method and/or means may depend, for example, on the particular hydrophobic coating. For example, in embodiments wherein the hydrophobic coating comprises wax the hydrophobic coating may be applied by contacting the dried foam with a solution of the wax in a suitable solvent (such as but not limited to a hexane solution containing from about 10% to about 20%, about 10% or about 20% of the wax) for a suitable amount of time (e.g., about 1 minute to about 5 minutes or about 3 minutes) followed by drying to remove residual solvent.

It will be appreciated by a person skilled in the art having regard to the present disclosure that the term “microfibrillated” as used herein in reference to lignocellulose refers to a fiber typically comprising sub-fibrous branches, at various length scales from tens of microns to sub-microns along the backbone in comparison to a complete lignocellulose microfibrillation to prepare highly viscous micro-fibrillated cellulose (MFC) and would be able to select a suitable lignocellulose source and/or preparation method accordingly. In an embodiment, the microfibrillated lignocellulose is obtained by a method comprising mechanical treatment of a lignocellulose source. The mechanical treatment can comprise any suitable method and/or means, the selection of which can be readily made by a person skilled in the art having regard to the present disclosure. In an embodiment, the mechanical treatment comprises mild disc milling (e.g., for a time of about 1 minute to about 1 hour or about 5 minutes to about 25 minutes, about 10 minutes or about 20 minutes) of the lignocellulose source to obtain the microfibrillated lignocellulose. It will also be appreciated by a person skilled in the art that the microfibrillated lignocellulose in the methods of preparing a foam of the present disclosure may contain small amounts of other lignocellulosic and/or cellulosic materials that not are in microfibrillated form (e.g., on the nanoscale) for example, less than about 5 wt %, 4 wt %, 3 wt %, 2 wt %, 1 wt %, 0.5 wt %, 0.1 wt % or 0.01 wt %. For example, in some embodiments, the woody component in the aqueous suspension comprises or consists essentially of the microfibrillated lignocellulose. In other embodiments, the woody component in the aqueous suspension consists of microfibrillated lignocellulose.

The lignocellulose source can be any suitable source of lignocellulose or combination thereof. The term “lignocellulose” as used herein refers to a plant biomass that is made up of cellulose, hemicellulose and lignin. In an embodiment, the lignocellulose source comprises, consists essentially of or consists of tree bark, tree branches, beetle-killed wood, fire-burnt wood, demolished wood, pulp (such as but not limited to kraft pulp, thermomechanical pulp, chemi-thermomechanical pulp or combinations thereof) refined wood fibers, wood processing waste (such as but not limited to wood shavings, sawdust or combinations thereof), agricultural residue (such as but not limited to rice straw; wheat straw; sugarcane bagasse, corn stalks, pineapple leaves or combinations thereof), fibrous crops or portions thereof (such as but not limited to cotton, hemp, sisal, ramie, rapeseeds, jute, kenaf, flax or combinations thereof), food processing waste (such as but not limited to juice pulp, peels or combinations thereof) or combinations thereof. In some embodiments, the lignocellulose source undergoes further processing prior to microfibrillation (e.g., refinement).

In an embodiment, the microfibrillated lignocellulose comprises, consists essentially of or consists of microfibrillated softwood chemi-thermomechanical pulp (CTMP), microfibrillated refined softwood wood chips, microfibrillated sawdust or combinations thereof. In another embodiment, the microfibrillated lignocellulose comprises, consists essentially of or consists of microfibrillated softwood chemi-thermomechanical pulp (CTMP). In a further embodiment, the microfibrillated lignocellulose comprises, consists essentially of or consists of microfibrillated refined softwood wood chips. In another embodiment, the microfibrillated lignocellulose comprises, consists essentially of or consists of microfibrillated sawdust. In another embodiment, the microfibrillated lignocellulose comprises, consists essentially of or consists of a combination of microfibrillated softwood chemi-thermomechanical pulp (CTMP) and microfibrillated sawdust. In an embodiment, the mass ratio of the microfibrillated softwood chemi-thermomechanical pulp (CTMP) to the microfibrillated sawdust is from about 0.1:9.9 to about 9.9:0.1, about 0.5:9.5 to about 4:8, about 0.5:9.5 to about 2:8, about 1:9 to about 2:8, about 1:9 or about 2:8.

The concentration of the microfibrillated lignocellulose in the aqueous suspension is any suitable concentration. In an embodiment, the concentration of the microfibrillated lignocellulose in the aqueous suspension is about 0.1 wt % to about 10 wt %. In another embodiment, the concentration of the microfibrillated lignocellulose in the aqueous suspension is about 2 wt % to about 8 wt %. In another embodiment, the concentration of the microfibrillated lignocellulose in the aqueous suspension is about 2 wt % to about 4 wt % or about 5 wt % to about 7 wt %. In an embodiment, the concentration of the microfibrillated lignocellulose in the aqueous suspension is about 3 wt %. In another embodiment, the concentration of the microfibrillated lignocellulose in the aqueous suspension is about 6 wt %.

Ground kaolinite (US$ about 100/tonne) was used as an exemplary fire retardant which may be used, for example, to develop a low cost, market-ready lignocellulosic foam that displays thermal insulation, fire retardancy and cost-effectiveness. As described in greater detail below; the structural features of individual wood fibers before and after microfibrillation were investigated, and microscopic analyses revealed the integration of kaolinite within the M-fiber matrix. The Taguchi's method was employed to examine the relative impact of key parameters on foam properties, including apparent density, mechanical and thermal performance, as well as fire retardancy. These parameters, relevant to the foam-lying process, included M-fiber concentration, surfactant concentration, and kaolinite loading in the precursor slurry. A formulation identified by the Taguchi's method was demonstrated for an optimal performance retention over three recycling cycles. Exemplary microfibrillated lignocellulose/organic fire-retardant composite foams were also prepared that exhibited fire resistance and thermal insulation.

Accordingly, in some embodiments, the aqueous suspension further comprises a fire retardant. The fire retardant can comprise any suitable fire retardant or combination thereof. For example, suitable inorganic fire retardants may include, for example, a clay (such as but not limited to kaolinite, halloysite, bentonite or combinations thereof) a suitable metal hydroxide (such as but not limited to ferric hydroxide, aluminum hydroxide or combinations thereof), gypsum, sodium bicarbonate, borate/boric acid, a suitable phosphate derivative, or combinations thereof. Suitable organic fire retardants may include, for example, a combination of polyethyleneimine (PEI) and phytic acid (PA). In an embodiment, the fire retardant comprises an inorganic fire retardant. In another embodiment, the fire retardant comprises, consists essentially of or consists of a clay. In another embodiment, the clay comprises, consists essentially of or consists of kaolinite. The ratio of clay (e.g., kaolinite) to microfibrillated lignocellulose can be any suitable ratio. In an embodiment, the clay (e.g., kaolinite)/microfibrillated lignocellulose ratio by weight is from about 0.1 to about 5, about 1 to about 3, about 1.5 to about 2.5, about 1 to about 2 or about 2. In another embodiment, the fire retardant comprises an organic fire retardant. In another embodiment, the fire retardant comprises, consists essentially of or consists of a combination of polyethyleneimine (PEI) and phytic acid (PA). The ratio of PEI to PA can be any suitable ratio. In an embodiment, the PEI and PA are present in about an equal ratio by weight. The ratio of the combined amount of the PEI and PA to the microfibrillated lignocellulose can be any suitable ratio. In an embodiment, the ratio of the combined weight of the PEI and PA to the microfibrillated lignocellulose is from about 1:9 to about 9:1, about 1:3 to about 4:3, about 2:3 to about 1:1 or about 1:1.

The drying of the wet foam to obtain the foam can comprise any suitable method and/or means, the selection of which can be made by a person skilled in the art. In an embodiment, the drying comprises heating. In an embodiment, the heating is under ambient pressure (e.g., in an oven or a similar means). In another embodiment, the heating is at a temperature of from about 40° C. to about 100° C., about 60° C. to about 90° C., about 75° C. or about 80° C. The drying is for a time suitable to remove a desired amount of moisture from the wet foam to obtain the foam. In an embodiment, the drying is for a time of about 2 hours to about 2 days, about 4 hours to about 12 hours, about 6 hours or about 10 hours. In an embodiment, the method comprises draining the wet foam to obtain a drained foam prior to drying.

In an embodiment, prior to drying, the wet foam is transferred to a mold. In such embodiments, the method may further comprise demolding the foam subsequent to drying.

The sub-fibrous structures of microfibrillated lignocellulose may serve as an in-situ binder to enlarge the contact area and strengthen physical entanglement during capillary force-driven assembly. This allows, for example, the preparation of a mechanically robust foam without the use of a binder. Accordingly, in some embodiments, the foam does not comprise a binder (i.e., is devoid of a binder). The term “binder” as used herein refers to an exogenous binder, for example, a chemical binder (such as but not limited to methylene diphenyl diisocyanate (MDI), citric acid and/or borates) and similar binders which would be suitable to add to lignocellulosic fibers to strengthen the structure of a foam prepared therefrom but does not include in-situ binders such as lignocellulosic and/or cellulosic fibers.

The present disclosure also includes a method of preparing a recycled foam, the method comprising:
preparing an aqueous dispersion comprising a foam prepared from a method of preparing a foam as described herein, wherein the foam does not comprise a binder; and
drying the aqueous dispersion to prepare the recycled foam.

The present disclosure also includes a foam prepared by a method of preparing a foam of the present disclosure. It will be appreciated by a person skilled in the art that embodiments relating to such foams can be suitably varied as described herein for the methods of preparing a foam of the present disclosure.

The present disclosure also includes a foam comprising microfibrillated lignocellulose. In an embodiment, the microfibrillated lignocellulose is obtained by a method comprising mechanical treatment of a lignocellulose source. The mechanical treatment can comprise any suitable method and/or means, the selection of which can be readily made by a person skilled in the art having regard to the present disclosure. In an embodiment, the mechanical treatment comprises mild disc milling (e.g., for a time of about 1 minutes to about 1 hour or about 5 minutes to about 25 minutes, about 10 minutes or about 20 minutes) of the lignocellulose source to obtain the microfibrillated lignocellulose. It will also be appreciated by a person skilled in the art that the microfibrillated lignocellulose in the foams of the present disclosure may contain small amounts of other lignocellulosic and/or cellulosic materials that not are in microfibrillated form (e.g., on the nanoscale) for example, less than about 5 wt %, 4 wt %, 3 wt %, 2 wt %, 1 wt %, 0.5 wt %, 0.1 wt % or 0.01 wt %. For example, in some embodiments, the woody component in the foam comprises or consists essentially of the microfibrillated lignocellulose. In other embodiments, the woody component in the foam consists of microfibrillated lignocellulose.

The lignocellulose source can be any suitable source of lignocellulose or combination thereof. In an embodiment, the lignocellulose source comprises, consists essentially of or consists of tree bark, tree branches, beetle-killed wood, fire-burnt wood, demolished wood, pulp (such as but not limited to kraft pulp, thermomechanical pulp, chemi-thermomechanical pulp or combinations thereof) refined wood fibers, wood processing waste (such as but not limited to wood shavings, sawdust or combinations thereof), agricultural residue (such as but not limited to rice straw, wheat straw, sugarcane bagasse, corn stalks, pineapple leaves or combinations thereof), fibrous crops or portions thereof (such as but not limited to cotton, hemp, sisal, ramie, rapeseeds, jute, kenaf, flax or combinations thereof), food processing waste (such as but not limited to juice pulp, peels or combinations thereof) or combinations thereof. In some embodiments, the lignocellulose source undergoes further processing prior to microfibrillation (e.g., refinement).

In an embodiment, the microfibrillated lignocellulose comprises, consists essentially of or consists of microfibrillated softwood chemi-thermomechanical pulp (CTMP), microfibrillated refined softwood wood chips, microfibrillated sawdust or combinations thereof. In another embodiment, the microfibrillated lignocellulose comprises, consists essentially of or consists of microfibrillated softwood chemi-thermomechanical pulp (CTMP). In a further embodiment, the microfibrillated lignocellulose comprises, consists essentially of or consists of microfibrillated refined softwood wood chips. In another embodiment, the microfibrillated lignocellulose comprises, consists essentially of or consists of microfibrillated sawdust. In another embodiment, the microfibrillated lignocellulose comprises, consists essentially of or consists of a combination of microfibrillated softwood chemi-thermomechanical pulp (CTMP) and microfibrillated sawdust. In an embodiment, the mass ratio of the microfibrillated softwood chemi-thermomechanical pulp (CTMP) to the microfibrillated sawdust is from about 0.1:9.9 to about 9.9:0.1, about 0.5:9.5 to about 4:8, about 0.5:9.5 to about 2:8, about 1:9 to about 2:8, about 1:9 or about 2:8.

In methods of the examples described in greater detail below, most of the surfactant drained with water but residual surfactant may remain e.g., on the microfibrillated lignocellulose fibers comprised in the foam. Accordingly, in some embodiments, the foam further comprises a foaming agent. The foaming agent can be any suitable foaming agent, for example, as described herein in the embodiments relating to the methods for preparing foams.

In an embodiment, the foam further comprises a hydrophobic coating. In some embodiments, the hydrophobic coating comprises wax. However, the hydrophobic coating can be any suitable hydrophobic coating, the selection of which can be made by a person skilled in the art. In an embodiment, the hydrophobic coating comprises, consists essentially of or consists of wax, a plant-distilled oil, rosin, a reaction product of hydroxyl groups comprised in the foam with an alkyl ketene dimer or combinations thereof. In an embodiment, the hydrophobic coating comprises, consists essentially of or consists of wax. The way can be any suitable wax or combination thereof, the selection of which can be made by a person skilled in the art. For example, it would be appreciated by a person skilled in the art that the wax desirably has a melting temperature in a range suitable for the intended use of the foam, and could select a suitable wax or combination thereof accordingly. In an embodiment, the wax comprises paraffin, a natural wax (such as but not limited to palm wax, soybean wax, beeswax or combinations thereof) or combinations thereof. In an embodiment, the wax comprises, consists essentially of or consists of palm wax. The plant-distilled oil can be any suitable plant-distilled oil or combination thereof, the selection of which can be made by a person skilled in the art. In an embodiment, the plant-distilled oil comprises, consists essentially of or consists of tung oil, pine oil, limonene, linseed oil or combinations thereof. The alkyl ketene dimer can be any suitable alkyl ketene dimer or combination thereof, the selection of which can be made by a person skilled in the art.

In an embodiment, the foam further comprises a fire retardant. The fire retardant can comprise any suitable fire retardant or combination thereof. For example, suitable inorganic fire retardants may include, for example, a clay (such as but not limited to kaolinite, halloysite, bentonite or combinations thereof) a suitable metal hydroxide (such as but not limited to ferric hydroxide, aluminum hydroxide or combinations thereof), gypsum, sodium bicarbonate, borate/boric acid, a suitable phosphate derivative, or combinations thereof. Suitable organic fire retardants may include, for example, a combination of polyethyleneimine (PEI) and phytic acid (PA). In an embodiment, the fire retardant comprises an inorganic fire retardant. In another embodiment, the fire retardant comprises, consists essentially of or consists of a clay. In another embodiment, the clay comprises, consists essentially of or consists of kaolinite. The ratio of clay (e.g., kaolinite) to microfibrillated lignocellulose can be any suitable ratio. In an embodiment, the clay (e.g., kaolinite)/microfibrillated lignocellulose ratio by weight is from about 0.1 to about 5, about 1 to about 3, about 1.5 to about 2.5, about 1 to about 2 or about 2. In another embodiment, the fire retardant comprises an organic fire retardant. In another embodiment, the fire retardant comprises, consists essentially of or consists of a combination of polyethyleneimine (PEI) and phytic acid (PA). The ratio of PEI to PA can be any suitable ratio. In an embodiment, the PEI and PA are present in about an equal ratio by weight. The ratio of the combined amount of the PEI and PA to the microfibrillated lignocellulose can be any suitable ratio. In an embodiment, the ratio of the combined weight of the PEI and PA to the microfibrillated lignocellulose is from about 1:9 to about 9:1, about 1:3 to about 4:3, about 2:3 to about 1:1 or about 1:1.

In an embodiment, the foam does not comprise a binder (i.e., is devoid of a binder).

The present disclosure also includes all suitable uses of the foams of the present disclosure. For example, in an embodiment, the present disclosure includes a use of a foam of the present disclosure as described herein in insulation or packaging. In an embodiment, the use is in insulation. Accordingly, the present disclosure also includes insulation comprising a foam of the present disclosure. In another embodiment, the use is in packaging. Accordingly, the present disclosure also includes packaging comprising a foam of the present disclosure.

The following are non-limiting examples of the present disclosure:

### EXAMPLES

### Example 1: Air Drying Scalable Production of Hydrophobic, Mechanically Stable, and Thermal Insulating Lignocellulosic Foam

Demand for sustainable building thermal regulation is driving the development of low carbon-intensive, renewable, and safe-to-use materials to substitute the dominant synthetic polymers and inorganic mats. Among various renewable feedstocks feasible to produce thermal insulator, lignocellulose stands out due to its massive availability and its products' biodegradation potential (Abu-Jdavil et al., 2019; Li et al., 2022; Kumari et al., 2016). This study used a new mild mechanical pretreatment strategy which may be used, for example, to fabricate high-performance, self-strengthening thermal insulation board in a low cost and scalable approach from chemi-thermomechanical pulp (CTMP), a type of high-yield wood pulp. CTMP fibers, after subject to a short period of disc milling, were found to gain abundant sub-fibrous structures at multiple scales. After foaming and air-drying, such micro-fibrillated fibers (MF-CTMP) formed robust, binder-free foam under capillary force with remarkedly stronger physical entanglement between fibers compared to that of pristine CTMP, achieving 3.7 folds Young's modulus, 2.9 folds ultimate stress, and 1.9 folds ultimate toughness with respect to the latter. Another key consideration in developing competent lignocellulosic foam is the need of proper hydrophobic treatment to suppress water/moisture-induced structural aging and achieve long-term durability. A sustainable hydrophobic treatment approach can be learnt from nature, where plants generate a wax layer at their surfaces to protect their tissues, such as catkins (West & Salo, 1979) and leaves (de Freitas et al., 2019), from environmental disturbance. This inspires the potential of implementing wax coating for hydrophobic treatment of the lignocellulosic foam. Palm wax coating further provided a sustainable hydrophobic protection for the foam (contact angle of about) 110°. The constituents of palm wax are relatively inert and stable to the environment, endowing the wax with good performance retention in a long term (EFSA Panel on Food Additives and Nutrient Sources added to Food, 2012). Moreover, palm wax is classified by the United States Food and Drug Administration as Generally-Regarded-As-Safe (GRAS) (de Freitas et al., 2019), showing its non-toxic nature that is vital for indoor application. The high porosity and structural tortuosity endowed the hydrophobic MF-CTMP foam with excellent thermal insulation properties (thermal conductivity of 33.1±2.3 mW/m·K), demonstrating significantly better performance than a commercial glass fiber thermal insulator. Compared to other lignocellulosic boards prepared using freeze-drying or supercritical drying operations, the hydrophobic MF-CTMP foam represents a low cost, binder-free, and scalable technology which may be useful, for example, for commercial sustainable thermal insulation applications.

### I. Materials and Methods

a) Materials and chemicals: Softwood CTMP was obtained from Pulp and Paper Centre, University of British Columbia, BC, Canada. SDS (electrophoresis grade) and hexane (mixed isomers, ACS grade) were purchased from Fisher Scientific, MA, USA. Palm wax was produced by Hearts & Crafts, Brooklyn, NY, USA. Deionized (DI) water was generated using a Barnstead Mega-Pure Glass Stills (Thermo Fisher Scientific, Mississauga, ON, Canada) and used throughout the experiments. All chemicals were used as received without further purification. CTMP in the form of a 3 wt % aqueous suspension (fully hydrated for 3 days) was pretreated using a disc mill (Supermasscolloider, Masuko Sangyo Ltd., Japan). The gap between two abrasive contacting discs was set sequentially at 6 levels (i.e., 5, 2, 1, 0.5, 0.2, and 0.1), and CTMP was ground twice at each level, with a total time usage of 10 minutes to pretreat 300 g CTMP. The product was named and is optionally referred to herein as micro-fibrillated CTMP (MF-CTMP) and stored in a 4° C. fridge before use.
b) Size and water retaining property of CTMP and MF-CTMP: Fiber size was characterized using standard Fiber Quality Analyzer (FQA) method. Specifically, aqueous suspension of CTMP or MF-CTMP was sufficiently disintegrated to remove latent energy. Randomly sampled from the agitated suspension, 2 mL aliquot was transferred to a beaker containing 500 mL DI water and was then transferred to the sample station of an FQA analyzer (OpTest Equipment Inc., Hawkesbury, ON, Canada). For each sample, the length and width of >2000 individual fibers were recorded to obtain a representative dataset, based on which the weight-average length (L̅_{w}) and width (d̅) were calculated based on Eq. 1 and 2, respectively.

$${\overline{L}}_{w} = \frac{\sum {n}_{i} {L}_{i}^{2}}{\sum {n}_{i} {L}_{i}} \qquad Eq . 1$$

$$\overline{d} = \frac{\sum {n}_{i} {d}_{i}}{\sum {n}_{i}} \qquad Eq . 2$$

where, nᵢ refers to the n^{th} fiber recorded: Li and di represent the length and width of the n^{th} fiber. The width of each fiber is measured multiple times along its length.

Water retention value (WRV) of both CTMP and MF-CTMP was quantified following an industrial standard protocol (UM-256, TAPPI 2011) at Paper and Paper Centre, University of British Columbia, BC, Canada.
c) Preparation of CTMP or MF-CTMP foam: SDS was added to the 3 wt % aqueous CTMP or MF-CTMP suspension in a dosage range from 0 to 1 g/L. The whole suspension was transferred to a high-speed atomizer (Mode E310 blender, Vitamix Corp., Cleveland, OH, USA) accessorized with a foam beaker (Aer Disc Container, Vitamix Corp., Cleveland, OH, USA) and subject to sufficient foaming operation. The wet foam was poured into a home-made mold with stainless steel gauze bottom to allow drainage of free water. The mold carrying the drained foam was then transformed into foam via oven heating at 80° C. for 10 h. All demolded foams were stored in plastic bags at ambient temperature.
d) Hydrophobic modification of foam: Hexane solution containing 10% or 20% palm wax was prepared by adding the designated amount of wax into hexane in an air-tight glass vessel, which was kept under agitation until complete dissolution. Foam was immersed in the hexane solution for a fixed 3 minutes, lifted and tilted to drain excessive solution, and placed on a paper towel to allow the evaporation of hexane. The wax dip-coated foams were stored in plastic bags at ambient temperature.
e) Morphology of lignocellulosic fibers and assembled foam: Microscale morphologies of both CMTP and MF-CTMP were examined using Polyvar polarized optical microscope (POM: Olympus Corporation, Tokyo, Japan). Sample was prepared by depositing a 1 wt % aqueous suspension of CTMP or MF-CTMP on a glass slide. The nanoscale morphology of MF-CTMP was further evaluated using a Tecnai Spirit TEM (FEI Technologies Inc., OR, USA), operated at a 120 kV accelerating voltage. Sample was prepared by depositing 0.01 wt % aqueous MF-CTMP suspension on a glow-discharged formvar/carbon supported copper grid, followed by negative staining using 2% uranyl acetate. Morphology of foam was evaluated using a Meiji Techno ML5000 Compound Microscope (Cole-Parmer Canada Company, Quebec, QC, Canada) and Helios NanoLab 650 FIB-SEM (ThermoFisher Scientific Inc., Waltham, MA, USA). Samples were sputter-coated with 10 nm of Iridium (Leica EM MED020) Coating System, Leica Microsystems, Wetzlar, Germany) prior to image capturing using the SEM, at a working spacing of 5 mm and an accelerating voltage of 10 kV. The porosity of foam was calculated based on the obtained ρₐ, as well as the densities of CTMP (1460 kg/m³: Bergström & Kolseth, 1989) and palm wax (998 kg/m³: US Coastal Guard, 1999).
f) Mechanical test: Mechanical properties of lignocellulosic foam were measured using an Instron 5969 Uniaxial Materials Testing System (Instron Ltd., Norwood, MA, USA). Foam sticks of 20.0±0.2 mm in length, 20.0±0.2 mm in width, and 20-50 mm in height were cut from the foam and conditioned at 22° C. and 40% relative humidity (R.H.) overnight. Compressive test was conducted by consecutively compressing the foam to a strain of 80% in axial direction. The Young's modulus was calculated based on the stress-strain response in the initial linear regime (within a strain range of 0-5%). Breakage test was carried out using stick samples (220±2 mm in length, 20.0±0.5 mm in width, and 15.0±0.5 mm in height). The foam stick was placed on two solid supports with 8 cm spacing, and a 500 g weight was placed on top of the stick.
g) Contact angle and moisture uptake: The water contact angle was quantified using Theta Flex (Biolin Scientific, Espoo, Finland). Samples were cut into small pieces and attached onto glass slides. A droplet of 4 μL deionized water was dropped on the foam surface using a micro syringe. The contact angle was measured every 1 s for 1 min. Moisture uptake measurement was conducted in a cylindrical container filled with saturated solution of KNO₃ serving as moisture chamber (R.H. of 94% at 25° C.). Foam samples pre-dried at 105° C. for 24 h were placed in the container without direct contact with the salt solution, and the weight gain was measured using analytical balance (with accuracy of 0.1 mg) after designated periods of time.
h) Thermal insulation: Thermal insulation performance was quantified by determining the thermal conductivity (k) of foam in MTPS method using a Thermal Conductivity Analyzer (TCi, C-Therm Technologies Ltd., Fredericton, NB, Canada). Infrared (IR) imaging was taken using a handheld IR Thermal Imagining camera (RoHS HT-19, Xintai Instrument Ltd., Guangdong. China), and the experiments were conducted on a hot plate.
i) Statistical analysis: All experiments were conducted using at least 3 replicates, except duplicate conducted in WRV measurement. The results were presented in the form of “mean value=standard deviation”. Statistical analyses of the data were conducted using Minitab (version 15).

### II. Results and Discussion

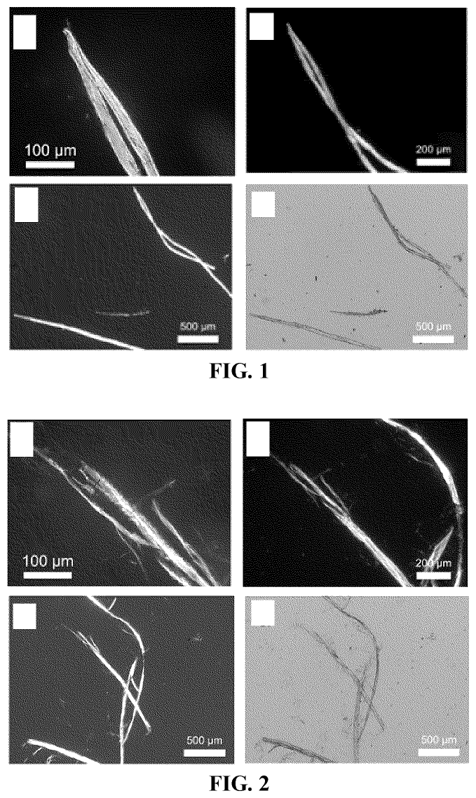

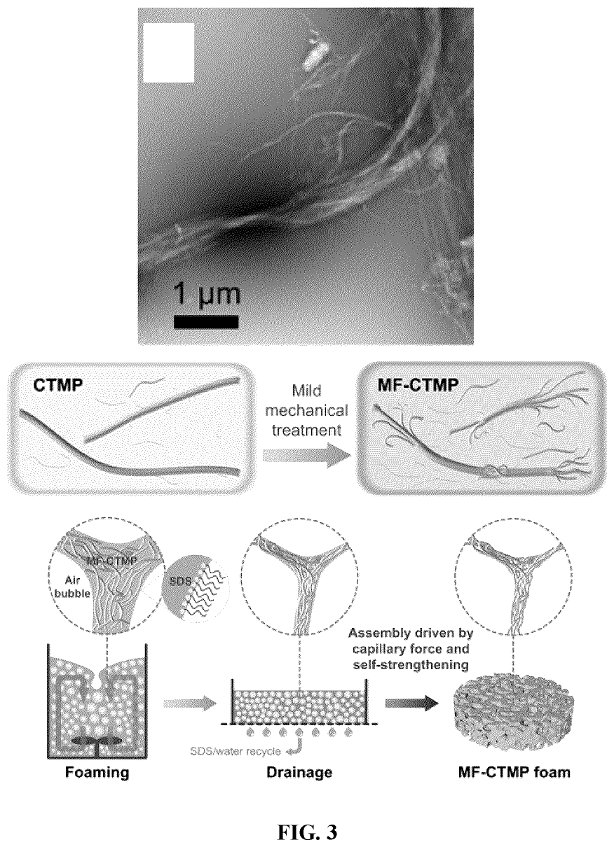

a) Impact of wet disc milling on CTMP fiber size and morphology: Softwood CTMP, a common lignocellulosic commodity sourced from spruce, pine, and fir at a high yield of up to 95% (Gonzalez et al., 2011), was selected as the model lignocellulose fiber for this study due to its massive production, high feedstock utilization, low chemical intensity, and low cost. A single CTMP fiber comprises arrays of lignocellulosic microfibril bundles, arranged mostly in parallel due to the way they are initially produced by plant cells (Li et al., 2021c). Such structure makes CTMP fibers possible to be partially or completely converted into microfibers when subject to mechanical treatment such as grinding, compressing, fiberizing, and fluffing. In this study, mechanical treatment of CTMP was achieved using wet fine disc milling. As shown by OM images, pristine CTMP exhibited a typical linear structure with smooth surface (FIG. 1). After disc milling (i.e., MF-CTMP), abundant fluffy sub-fibrous branches, at various length scales from tens of μm (FIG. 2) to sub-μm (FIG. 3: upper image), were created along the fiber's backbone. In particular, the end of certain individual fibers was found severely laterally separated into sub-fibers. On the other hand, the linear fiber backbone of CTMP was to some degree preserved in MF-CTMP (FIG. 2). Such phenomenon is expected as much milder disc milling (10 min) was conducted in this study as compared to that used for a complete lignocellulose micro-fibrillation, e.g., 2-3 h required for highly viscous micro-fibrillated cellulose (MFC: Wang et al., 2016). Hence, mild mechanical milling is able to introduce hierarchical, sub-fibrous branches throughout the CTMP backbones, in line with the anticipated effect of mechanical treatment.

It was hypothesized that certain micro-fibrillation would endow such linear, high lignin-containing fibers with sub-fibrous branches (FIG. 3, middle schematic: Morphology variation of CTMP fibers before and after mild disc milling; and lower schematic: exemplary preparation of MF-CTMP foam via SDS foaming, drainage, and oven drying). Mimicking the role of CNF binder as reported elsewhere (Hafez et al., 2021: Theng et al., 2015), the sub-fibrous structures were expected by the inventors to serve as the in-situ binder to enlarge the contact area and strengthen the physical entanglement between CTMP fibers during capillary force-driven assembly. This would lead to the production of mechanically robust foam without the use of external binder/crosslinkers and at lower costs than using CNF.

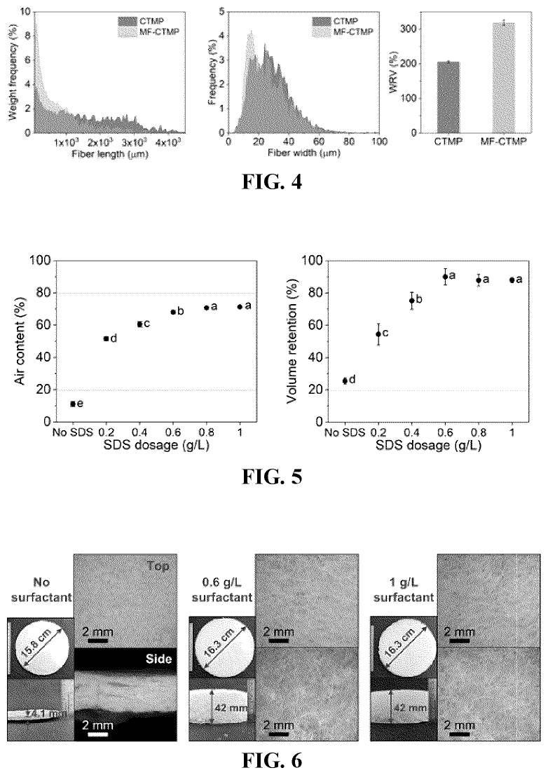

Insights into the impact of disc milling on CTMP's morphology and size were provided by FQA measurement. Clearly, the profile of length distribution shifted leftwards after disc milling (FIG. 4, left plot), with Lw reduced from 1.50 mm for CTMP to 0.76 mm for MF-CTMP. Meanwhile, the weight percentage of fines, defined as fibers with length below a cut-off of 70 μm, increased from 10.4% to 24.6%. This suggested the generation of large quantities of fiber segments owing to the grinding and cutting effect of mechanical treatment. On the other hand, disc milling created sub-fibrous structures along the fibers via fiberizing and fluffing effect, which accounted for the width distribution profile shifting leftwards after disc milling (FIG. 4, center plot), with d decreasing from 28.5 μm to 26.3 μm. WRV measurement can provide an indirect evaluation of fibrillation (Gu et al., 2018). The WRV of CTMP was found to increase from 205% to 319% after disc milling (FIG. 4, right plot), which is ascribed to the increased surface area and exposure of more hydrophilic groups (i.e., hydroxyls) to the outside due to the creation of abundant sub-fibrous structures in MF-CTMP.
b) Foam morphology and properties: The foam was prepared via a benchtop foaming-drainage-drying approach. Wet foam was prepared from 3 wt % MF-CTMP suspension, with SDS serving as the foaming agent to create porosity in the foam. The foaming apparatus, equipped with an axial flow impeller, enabled sufficient homogenization and aeration of the wet slurry feed. Increasing SDS dosage (in the range of 0)-0.8 g/L) reduced water surface tension and substantially improved the stability of the generated air bubbles, leading to greater air content in the wet foam (FIG. 5, left plot). Such value appeared to plateau when SDS dosage exceeded 0.6 g/L, which, while not wishing to be limited by theory, may be attributed to the massive generation of small bubbles at high SDS dosage regime without further elevating the overall air content remarkedly (Prakash et al., 2019).

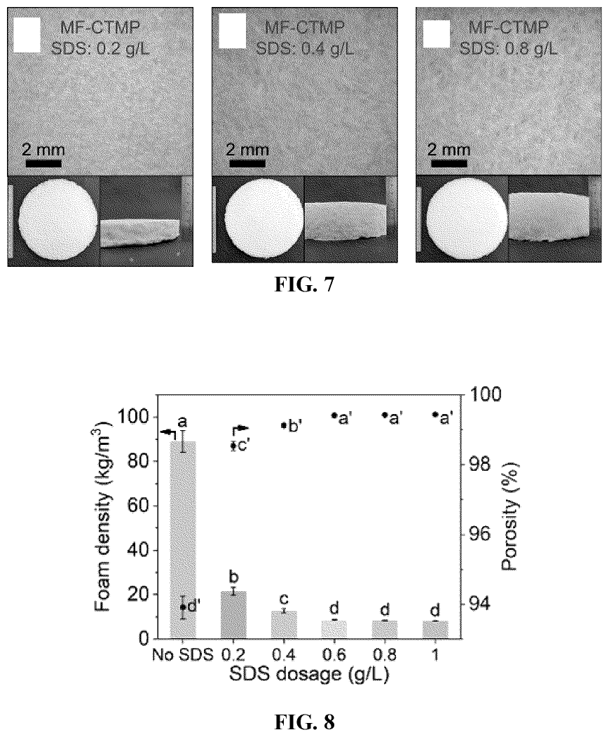

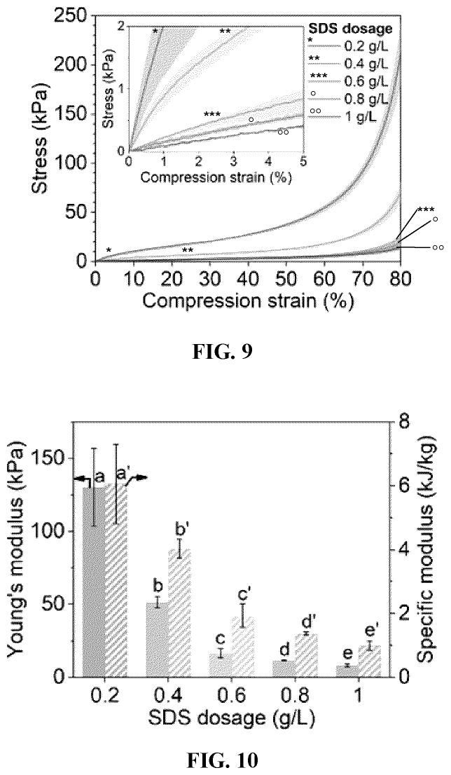

The aerated wet foam was then subject to a two-stage drying, initially drained in a cylindrical mold to remove excessive water, followed by complete drying into MF-CTMP foam in an oven. Similar to the trend of air content in the wet foam, more volume can be preserved during draining and drying with increasing SDS content (FIG. 5, right plot), which plateaued at SDS concentration above 0.6 g/L. The remaining water in the drained foam was further removed at the second drying stage, ending up with 3D interconnected foam (FIG. 6 and FIG. 7). The impact of SDS dosage on hindered shrinkage of wet foam was reflected by the reduced foam's apparent density (ρₐ: from 89.0±4.8 to 8.6±0.2 kg/m³) and increased porosity (from 93.9 to over 99.4%) (FIG. 8), both appearing to plateau when SDS dosage exceeded 0.6 g/L. The mechanical property of the foams was evaluated by compression test. Clearly, foams prepared with high SDS dosage exhibited lower stress at the same compression strain (FIG. 9), and lower Young's modulus, and lower specific modulus (FIG. 10). While not wishing to be limited by theory, this may be explained by the less compact assembly of MF-CTMP fibers. Specifically, high SDS dosage facilitated the generation of abundant tiny bubbles. These bubbles with high Laplace pressure can be entrapped between MF-CTMP fibers to withstand their coalescence into more compact bundles or clusters.

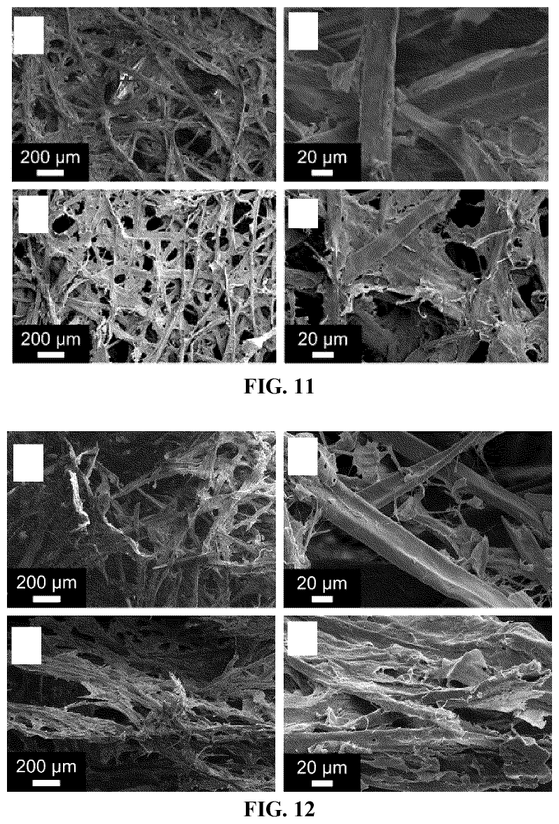

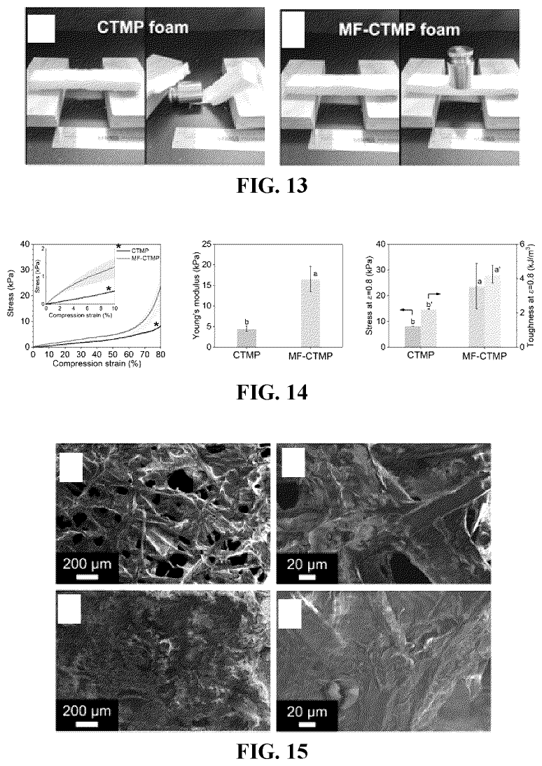

An SDS dosage of 0.6 g/L was sufficient to obtain the highest foam porosity (FIG. 8), while further increasing SDS dosage does not affect the porosity but tends to reduce the mechanical properties (FIG. 10). This threshold SDS dosage was used in the following experiments, to obtain highly porous and mechanically strong foam with minimum chemical usage. To evaluate the impact of disc milling, the microscopic structures of foams made from CTMP and MF-CTMP are compared using SEM. Both the external surfaces (FIG. 11) and the internal structures (FIG. 12) of foams were found to be assembled by randomly oriented lignocellulosic fibers. Compared to pristine CTMP that gave relatively smoother fiber surface, the disc milled CTMP clearly possessed higher surface roughness with abundant multi-scale hierarchical structures, in line with the OM results. Particularly, compared to the limited inter-fiber contact in the pristine CTMP foam (FIG. 11, upper right image), the contact region between individual fibers in the MF-CTMP foam (FIG. 11, lower right image) was wrapped by massive sub-fibrous structures. Such joints strengthened the interactions between fibers with enhanced physical entanglement and could improve the foam's mechanical properties. As demonstrated in a breakage test (FIG. 13), the MF-CMTP foam specimen was robust enough to hold a 500 g load without breaking, whereas the CTMP one immediately broke into halves under the same weight. Further quantitative analysis was conducted through compression test (FIG. 14, left plot). Though MF-CTMP fibers were much shorter than that of pristine CTMP (Lw being only half of the latter), the assembled foam exhibited much higher stress than the CTMP foam at the same strain. The Young's modulus, ultimate stress (at strain of 0.8), and ultimate material toughness of MF-CTMP foam were respectively 3.7, 2.9 and 1.9 folds, with respect to the case of CTMP (FIG. 14, center and right plots). All these results supported the benefit of mild mechanical pretreatment in developing robust, binder-free lignocellulosic foams.

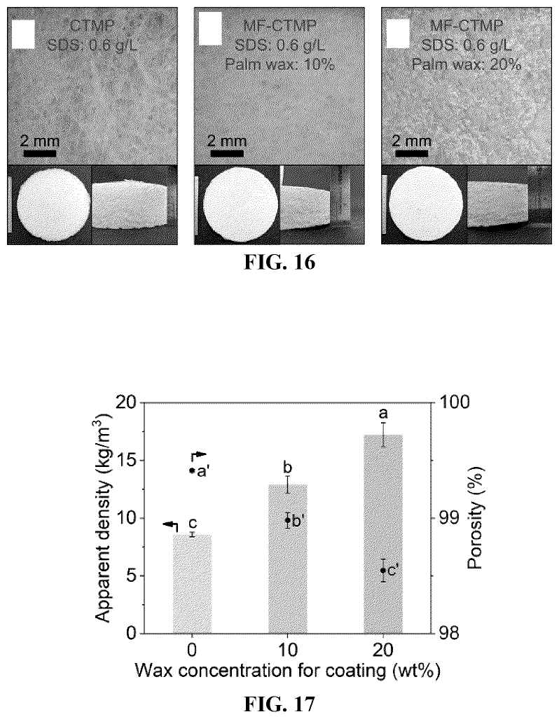

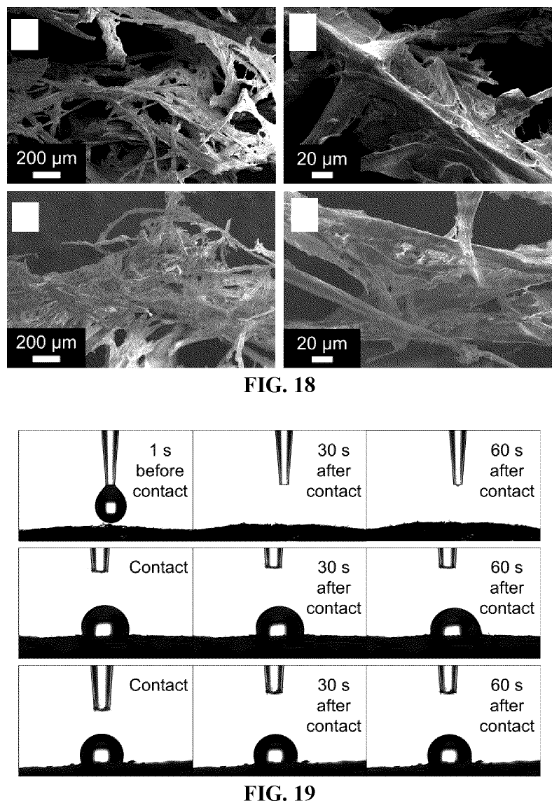

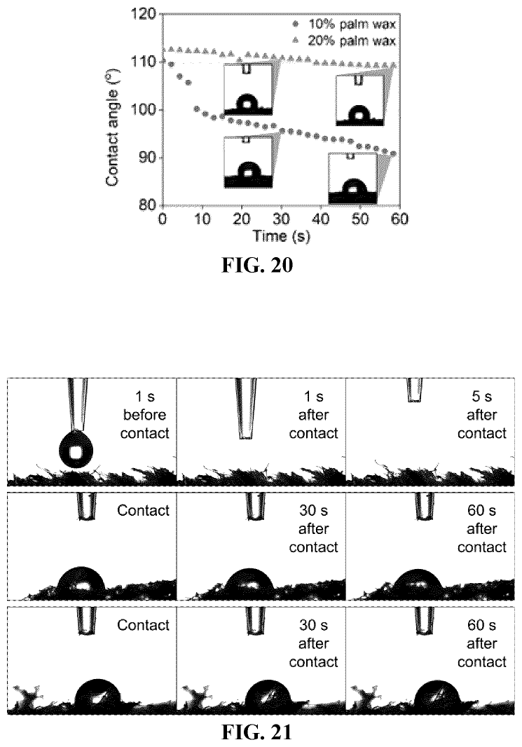

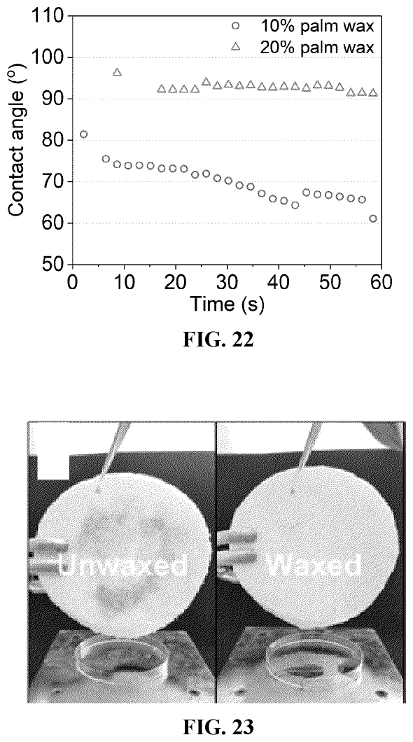

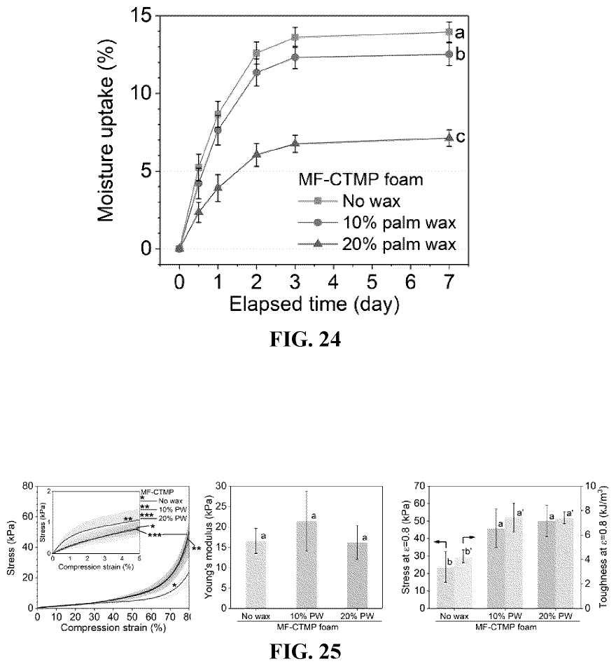

Due to the highly porous structure and enhanced mechanical property, the developed MF-CTMP foam may serve as a promising sustainable platform for potential applications such as absorbent, acoustic and thermal insulating material, as well as package cushioning. To improve the overall foam's service life, the pristine foam requires certain hydrophobic treatment for enhanced shape fidelity and durability against environmental water/moisture. To achieve so, the foam was dip coated using palm wax, a bio-based wax with hard texture and high melting point (about 83° C.). Results showed that palm wax coated surrounding the fiber matrix at the surface of the foams (FIG. 15 and FIG. 16). Increasing the wax solution concentration allowed more complete wax coating on foams, as indicated by the less and smaller openings observed at the external surfaces (FIG. 15, lower images), as well as the increased foam density and reduced porosity (FIG. 17). Interestingly, in contrast to the more complete wax coating at the external surface, the internal structure of the foam was less coated (FIG. 18). Such heterogeneous coating can be explained by the diffusion of wax, due to the migration of its carrier solvent (i.e., hexane) from the foam's interior to the surfaces driven by its evaporation. Such localized hydrophobic modification was found to improve the water repellency of the overall foam with minimum wax use, as confirmed by the water contact angle analysis. The wax-free foam absorbed water droplet within a few seconds (FIG. 19). In comparison, the foam dip-coated using 10% wax solution exhibited certain water resistance with corresponding contact angle gradually reducing from about 110° to about 90° within 1 min (FIG. 20), while not wishing to be limited by theory, probably due to an incomplete coating. Increasing the wax solution concentration to 20% achieved a more complete hydrophobic coating to hold water droplet, with contact angle decreasing merely by about 2° within 1 min (FIG. 20). The interior of the foam that was relatively less coated by wax gave lower contact angle correspondingly (FIG. 21 and FIG. 22). Since the foam was expected to be used as an integer and such overall hydrophobicity was considered satisfactory, further elevating the wax concentration beyond 20% was not conducted to minimize wax usage. In another water dripping test, the water extruded out from a pipette was immediately absorbed into the wax-free foam (FIG. 23), while the wax coated foam showed water resistance, as the majority of the dyed water slid away and got collected underneath (FIG. 23). Apart from improved water repellency, the wax coated foams also achieved enhanced moisture resistance, as indicated by their much lower equilibrium moisture uptake (7.1±0.5%) compared to the way-free ones (13.9±0.7%; FIG. 24). It is notable that the moisture uptake of the wax coated foam conforms to the ASTM standard (i.e., moisture content <10 wt %, ASTM C208-22). Overall, these results collectively demonstrated the excellent water and moisture resistance of palm wax-coated MF-CTMP foam.

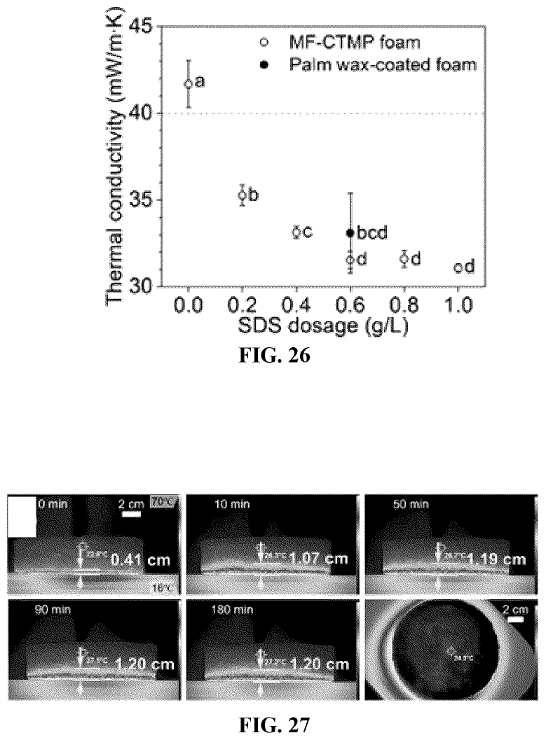

Regarding the impact on mechanical properties, the wax coating appeared to have negligible effect on the compression behavior in a low strain region of <30% (FIG. 25), resulting in no difference in the Young's modulus as compared to the uncoated one. Yet, wax coated foam seemed to exhibit higher stress than the uncoated one in the high strain region (i.e., 30-80%), leading to a higher toughness at strain of 80%. The negligible change in compressive properties at lower strain indicates lack of reinforcing effect of the palm wax as the wax does not form chemical crosslinking with the MF-CTMP. The increased stress at higher strain should be ascribed to the increased density of the wax coated foam, as the compression stress depends on ρₐ in the densification regime.
c) Application of MF-CTMP foam in thermal insulation: The high porosity and the multi-scale hierarchical tortuosity of the MF-CTMP foams suggests its potential thermal regulation function. The thermal conductivity (k) of the MF-CTMP foams gradually decreased from 41.7±1.3 to 31.1±0.2 mW/m·K, with increasing SDS dosage (FIG. 26), showing an inverse relationship with the porosity. This is due to the restrained heat transfer via solid conduction at lower solid fraction. By comparing the foam's k (as low as 31.1±0.2 mW/m·K) to that of air (25.9 mW/m·K), it is clear that the heat transfer via air conduction was the dominant contributor. The foams pretreated using 20% palm wax solution gave k of 33.1±2.3 mW/m·K, showing no statistical difference with the wax-free one but possessing a greater degree of fluctuation. This is reasonable as the coated wax altered the porosity of the foam, especially at the surface, varied the heat transfer via solid conduction, and therefore changed the thermal insulation performance of the overall foam.

It is important to notice that such k range, comparable to those previously reported values (Table 1), was achieved without the implementation of high-cost, energy-intensive, and time-consuming methods, i.e., freezing/freeze-drying (Zhu et al., 2022: Ren et al., 2022) and solvent exchange/supercritical drying (Karadagli et al., 2015). These strongly suggest the great potential of the air-dried MF-CTMP foam for thermal insulation application.

TABLE 1
Properties of lignocellulose-based thermal insulators
prepared via freeze drying or supercritical drying.

| | | | Thermal | |
|---|---|---|---|---|
| Drying | | Density | conductivity | |
| approach | Materials | (mg/cm³) | (mW/m · K) | Reference |
| Air drying | CTMP | 8.2-89 | 31-42 | This study |
| Freeze drying | LCNF | 11.9 | 31-32 | Zhu et al., 2022 |
| | TEMPO-CNF | 4-200 | 18-70 | Sakai et al., 2016; |
| | | | | Jiménez-Saelices et al., 2017; |
| | | | | Jiménez-Saelices et al., 2018; |
| | | | | Zhou & Hsieh, 2020 |
| | CNF | 8-20 | 26-39 | Gupta et al., 2018 |
| | CNF | 6.5-22.6 | 28-31 | Jiang et al., 2021 |
| | Regenerated | Unavailable | 33-38 | Ahmadzadeh et al., 2015 |
| | cellulose | | | |
| | Nanocrystalline | 20-27 | 27-41 | Wang et al., 2019 |
| | cellulose | | | |
| | CNF MOF | 41 | 227 | Zhou et al., 2020b |
| Supercritical | TEMPO-CNF | 4-40 | 18-38 | Sakai et al., 2016; |
| drying | | | | Kobayashi et al., 2014 |
| | Microcrystalline | 9-137 | 40-75 | Karadagli et al., 2015 |
| | cellulose | | | |

TEMPO: (2,2,6,6-Tetramethylpiperidin-1-yl)oxyl; CNF—cellulose nanofibril; MOF—metal-organic frameworks.

The foam's thermal insulation performance was demonstrated by placing a wax coated foam (prepared with 0.6 g/L SDS in foaming) onto a heating plate thermostatic at 70±0.5° C. As given in the IR images (FIG. 27), the height of the hot zone (green/yellow assigned as its boundary in color images) increased gradually from 0.41 to 1.19 cm within the initial 20 min and plateaued until the end of the measurement (3 h). In addition, the upper surface of the foam remained at a low temperature of 24.5° C. (FIG. 27, lower right image). This showed the impeded heat transfer inside the hydrophobic MF-CTMP foam.

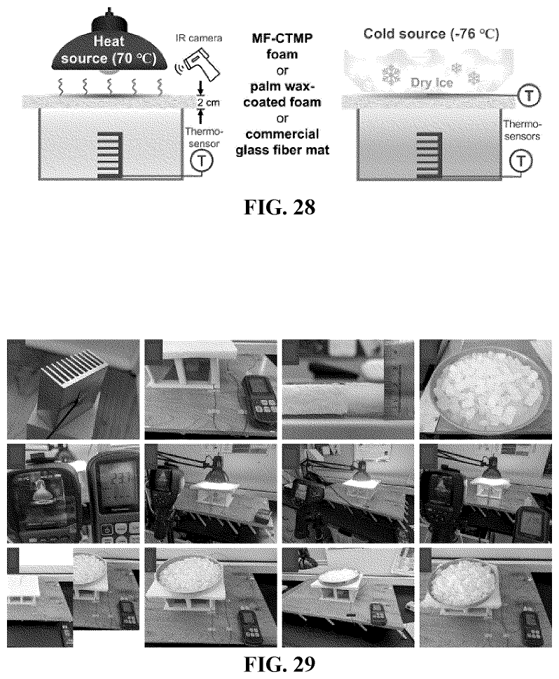

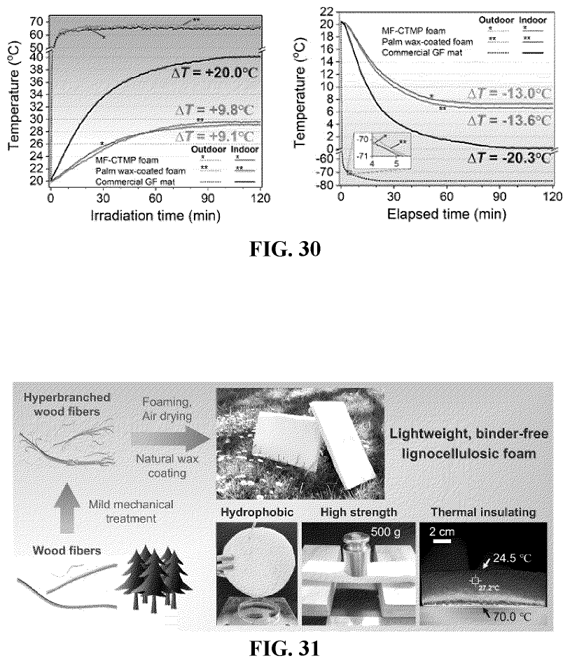

To further evaluate the thermal regulation performance, the MF-CTMP foam and the wax-coated foam were used as the ceiling board for a model bungalow (FIG. 28 and FIG. 29). The hot scenario was created using a high-power incandescent lamp, while the cold scenario was created by using dry ice. A commercial GF mat was employed as the industrial reference, with all the specimen's thickness kept at 2 cm. In the hot scenario, the outdoor temperatures rapidly exceeded 60° C. within 5 min and plateaued at around 65° C. after 20 min (FIG. 30, left). When MF-CTMP foam was used as the ceiling material, the indoor temperature gradually increased by 9.1° C. within 90 min and plateaued thereafter, which was less than half of the temperature change for the GF mat case, i.e., 20.0° C. The palm wax-coated foam performed similar to that of pristine foam, ending up with a greater temperature increase of 9.8° C., which can be attributed to the higher heat conduction via solid matrix. A similar phenomenon was observed in the cold scenario. The indoor temperature gradually decreased by 13.0 and 13.6° C. within 60 min for the wax-free and wax-coated MF-CTMP foams (FIG. 31, right), respectively, roughly two thirds of the variation for the GF mat case. These results straightforwardly demonstrated the better thermal insulation performance of the MF-CTMP foam, regardless of palm wax coating or not, compared to a common commercial thermal insulation product.

### III. Further Discussion

A mild mechanical pretreatment strategy is disclosed and demonstrated to facilely convert woody feedstocks (e.g., CTMP) into platform material with hyper-branched, micro-fibrillated geometry (e.g., MF-CTMP) via disc milling (see, e.g., FIG. 31). The created multi-scale hierarchical branches in MF-CTMP were verified by OM and TEM, which provided the fiber with an increased water retaining capability (WRV increased from 205% to 319%). Such abundant sub-fibrous structures allowed MF-CTMP to be assembled into mechanically robust porous foam without the need of external binders. Compared to the foam prepared from pristine CTMP, the MF-CTMP foam exhibited 3.7 folds Young's modulus, 2.9 folds ultimate stress (at strain of 0.8), and 1.9 folds ultimate material toughness, showing much stronger physical entanglement and a self-strengthening property between MF-CTMP fibers. The hydrophobic modification of the MF-CTMP foam was readily achieved using palm wax dip coating, with the foam's surface gaining good water repellency (contact angle of about) 110°. With a thermal conductivity as low as 33.1±2.3 mW/m·K, the palm wax-coated MF-CMTP foam can be used for thermal insulation purposes. A bench-top demonstration showed that when serving as the ceiling material, this foam substantially mitigated the response of indoor temperature to the outdoor compared to a commercial glass fiber mat (9.8° C. vs. 20.0° C. in the hot scenario and 13.6° C. vs. 20.3° C. in the cold scenario). Considering its low cost, ease of operation, and the potential of scale up, this facile strategy to obtain hyper-branched lignocellulosic fibers and hydrophobic, self-strengthening foams has a great promise, for example, for developing commercial a thermal insulation product from sustainable biomass feedstocks.

### Example 2: Binder-Free, Oven-Dried Lignocellulose/Clay Composite Foams: Fire Retardancy, Thermal Insulation and Recyclability

Global efforts to reduce carbon emissions and improve thermal comfort demand sustainable, safe-to-use insulative materials. This study advances a new type of binder-free lignocellulose/clay composite foams as sustainable alternative to the currently used synthetic and glass/mineral counterparts. A pressurized disc milling unraveled sub-micron “hairy” fibrillation on the surface of wood fibers (microfibrillated fibers, M-fiber). Such fibrillated fibers were then subjected to a foam laying process, with kaolinite incorporated as efficient and cost-effective fire retardant. Upon oven-drying, the foams displayed suitable structural and mechanical robustness. A clay retention of up to two-fold by weight was achieved without compromising the properties of the foam, removing the need for addition of chemical binders. The foam density, mechanical, thermal, and fire retardancy properties were systematically investigated with respect to the relative fiber loading as well as surfactant and clay addition. A low thermal conductivity (43.7±0.7 mW/(m·K)) and high fire retardancy capacity (limiting oxygen index of ˜43%) were demonstrated for hybrid foams of apparent density of 136±1 kg/m³ that also displayed good compressive strength (Young's modulus of 0.805±0.158 MPa). Remarkably, owing to the absence of chemical binding, facile recyclability was demonstrated over three cycles, with no significant penalty on performance. Overall, this work discloses a readily scalable technology which can be used, for example in preparing safe-to-use, recyclable lignocellulose/clay composite foams e.g., for building insulation.

### I. Materials and Methods

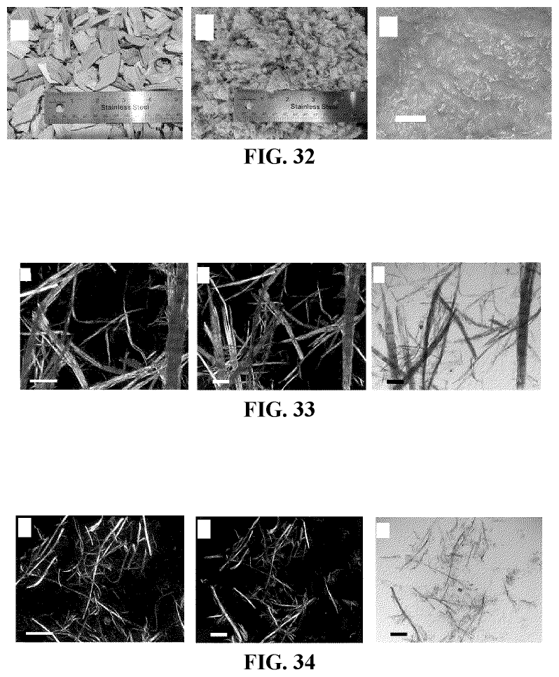

a) Materials and chemicals: Softwood wood chips (mixture of spruce, pine, fir, and hemlock), provided by Yinka Dene Economic Development Limited Partnership (Burns Lake, BC, Canada), were refined without bleaching by a local refining plant in western Canada at a dry mass retention of 96.8% (FIG. 32). The refined wood fibers (R-fiber) were stored at 4° C. in a fridge. Technical grade alpha olefin sulfonate (C14-C16) was purchased from Univar Solutions Inc. (Downers Grove, IL, USA) and used as the foaming surfactant. Kaolinite clay was purchased from Amson Naturals (Richmond Hill, ON, Canada). Commercial expanded polystyrene (EPS) foam (density of 29.8 kg/m³) was purchased from a local retailor. All chemicals were used as received without further purification. R-fiber in the form of 3 wt % aqueous suspension, after being soaked for 3 days, was mechanically grinded using a disc grinder (Masuko Sangyo Ltd., Japan). The gap between the two abrasive discs was set sequentially from 5 to 0.1 (dimensionless), within a total grinding time of 20 min that handle 300 g dry fibers. The resultant fibrillated fibers are herein optionally referred to as “micro-fibrillated wood fibers” (M-fiber: FIG. 32) and were stored in a fridge (4° C.) before use.
b) Morphology and moisture retention: Fiber morphology and dimensions were characterized using cross-polarized optical microscopy. An aqueous suspension of wood fibers was sufficiently disintegrated to remove latent energy. Samples were prepared by depositing 1 wt % aqueous suspension of R-fiber or M-fiber on a glass slide, which were then imaged using a Polyvar polarized optical microscope (POM: Olympus Corporation, Tokyo, Japan). The image was processed using ImageJ to automatically identify and record fiber length and width data. The water retaining behavior of both fibers was quantified following a standard protocol (UM-256, TAPPI 2011).
c) Preparation of lignocellulose/clay composite foam: The R-fiber or M-fiber, in the form of 3% aqueous suspensions, were mixed with designated amounts of the foaming agent (2 g/L with respect to slurry) and the kaolinite clay (clay/fiber mass ratio of 0.5, 1, 1.5, 2, or 2.5). The respective suspension was then transferred to a high-speed blender (Vitamix Corp., Cleveland, OH, USA) for foam formation. The degree of foaming was adjusted to allow constant foam volume after drainage. The wet foam was poured into a mold that allows the drainage of free water from the bottom. Most of the surfactant drained with water and, while not wishing to be limited by theory, there is no expectation of significant amount of residual surfactant adsorbed on the fibers. The mold carrying the drained wet foam was then dried for 6 h in a conventional oven at 75° C. The obtained, solid foams were stored in plastic bags at ambient conditions for further characterization. For Taguchi-L₉ design, a list of compositions is given in Table 2. The three levels of variations were determined according to preliminary tests. Particularly, a higher fiber content and a lower surfactant concentration were favored due to the low water and chemical intensity. The preliminary results showed 5 wt % as the highest fiber content that the foaming apparatus was able to handle: the fiber slurry was sufficiently foamed at 3 g/L surfactant addition. The clay mineral was added at a maximum clay/fiber ratio of 2, since higher ratios led to poor clay retention in the foam.

TABLE 2
Taguchi-L₉ orthogonal array of experimental design.

| Experimental | Fiber content | Surfactant | Clay/fiber |
|---|---|---|---|
| group | (wt %) | concentration* (g/L) | mass ratio |
| E1 | 3 | 1 | 1 |
| E2 | 3 | 2 | 1.5 |
| E3 | 3 | 3 | 2 |
| E4 | 4 | 1 | 1.5 |
| E5 | 4 | 2 | 2 |
| E6 | 4 | 3 | 1 |
| E7 | 5 | 1 | 2 |
| E8 | 5 | 2 | 1 |
| E9 | 5 | 3 | 1.5 |

*with respect to slurry

The signal-to-noise (S/N) ratio was used to represent the changes in selected performance indicators (apparent density, Young's modulus, thermal conductivity, and fire retardancy) due to the variations in the three processing parameters (Table 2) with respect to errors, as given in Equation 3.

$$S / N = - 10 log ( M S D ) \qquad Equation 3$$

where, MSD (mean square deviation) equals to

$$\frac{{\sum }_{i = 1}^{n} ( 1 / {y}_{i}^{2} )}{n}$$

for the larger-the-better case and

$$\frac{{\sum }_{i = 1}^{n} {y}_{i}^{2}}{n}$$

for the smaller-the-better case: n refers to number of observations; y; refers to the value of performance indicator in each experimental trial. Note that a larger-the-better mode of Taguchi method was applied to analyze foam's apparent density, Young's modulus, and limiting oxygen index (LOI), while a smaller-the-better mode was employed for thermal conductivity.
d) Morphology of lignocellulose/clay composite foams: The morphology of the solid foam was evaluated using Helios NanoLab 650 FIB-Scanning Electron Microscope (ThermoFisher Scientific Inc., Waltham, MA, USA). Samples were sputter-coated with 10 nm of Iridium (Leica EM MED020 Coating System, Leica Microsystems, Wetzlar, Germany) prior to image capturing using the SEM, at a working spacing of 5 mm and an accelerating voltage of 10 kV.
e) Solid foams characterization: The mechanical properties of the foams were quantified using an Instron 5969 Uniaxial Materials Testing System (Instron Ltd., Norwood, MA, USA). Foams of given dimensions (20.0±0.2 mm in length, 20.0±0.2 mm in width, and 25.0±0.2 mm in height) were prepared and conditioned overnight at 22° C. and 40% relative humidity. The compression tests were conducted at a compression rate of 2 mm/min until reaching a maximum strain of 82%. The foam's thermal insulation behavior was tested by determining the thermal conductivity using the MTPS method with a thermal conductivity analyzer (TCi, C-Therm Technologies Ltd., Fredericton, NB, Canada). The foam's fire retardancy was quantitatively examined using an LOI tester (Qinsun Instruments Co., Shanghai, China) in compliance with ASTM D2863. The samples were cut following the type II specimen requirements. Fire resistance demonstration was conducted by exposing the center of a sample board (15×15×1.3 cm²) directly to a butane torch (central temperature of 1,430° C.) for 20 s. All operations were carried out in a fume or ventilated hood.
f) Statistical analysis: All experiments were conducted using at least three replicates, except for the WRV measurements carried out in duplicate. The results were presented in the form of “mean value±standard deviation”.

### II. Results and Discussion

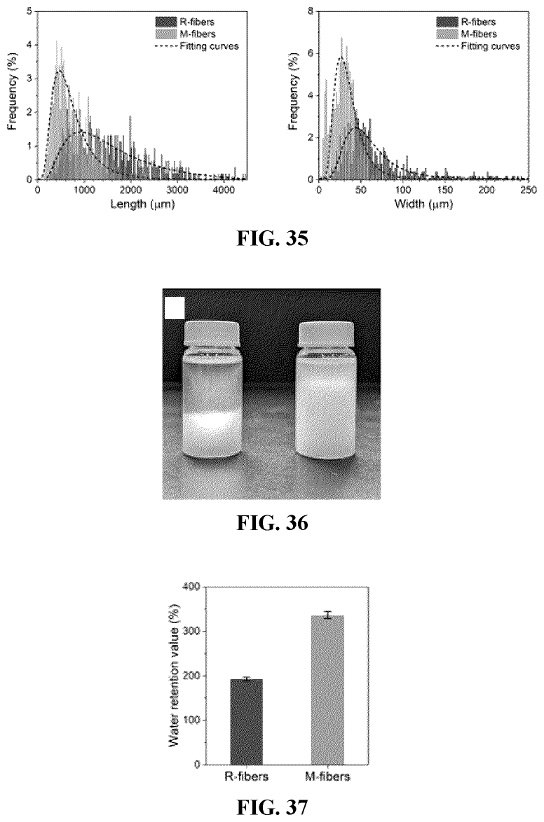

a) Size and morphology of R- and M-fiber, and interactions with kaolinite: Due to the strong inter- and intra-chain hydrogen bonding interactions of the glucan chains, oriented lignocellulosic microfibril bundles can be processed by mechanical fibrillation using disc milling, which liberates single microfibrils or bundles of fewer ones. In this example, mechanically refined softwood fibers, R-fiber, were treated using pressurized disc milling to produce M-fiber. As indicated in POM images, R-fiber showed a typical non-fibrillated morphology and appeared to have a wide size distribution (FIG. 33), with a large proportion of dry mass carried by the larger fibers. Certain branching and incomplete peeled-off fibrils were observed along the backbone of the R-fibers, especially the larger ones. In contrast, M-fiber exhibited much thinner and shorter dimensions (FIG. 34). The M-fiber possessed abundant fibrillar (“hairy”) structures along their length. This can be attributed to the compression, dislocation, and fibrillation effects that occur during pressurized disc milling. As shown in FIG. 35, a quantitative analysis suggested that the size of both fiber types can be described using log-normal fitting (adjusted R-square >0.8). The fitting results suggest an evident reduction in fiber's peak length (width) from 1.46 mm (53.3 μm) for R-fiber to 0.630 mm (31.9 μm) for M-fiber, while the high aspect ratio was measured to be 19.7. The reduced fiber dimensions accounted for the slower settling velocity of M-fiber suspended in water and the more turbid supernatant (FIG. 36), compared to those of R-fiber. As an indirect evaluation of fibrillation degree (Gu et al., 2018), the water retention value (WRV) of the fibers increased from (193±4) % to (336±8) % after pressurized disc milling (FIG. 37), reflecting an increased specific surface area due to the generation of abundant hairy structures (FIG. 33 and FIG. 34). Therefore, pressurized disc milling converted the refined wood fibers into structures carrying hierarchical, hairy fibrils.

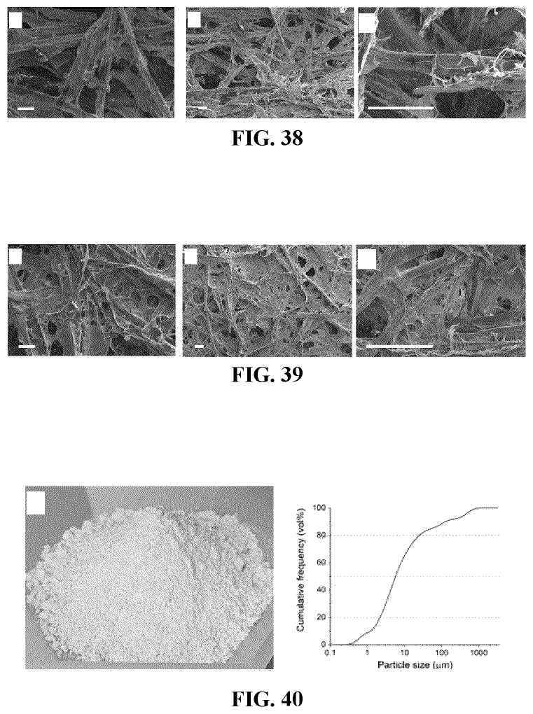

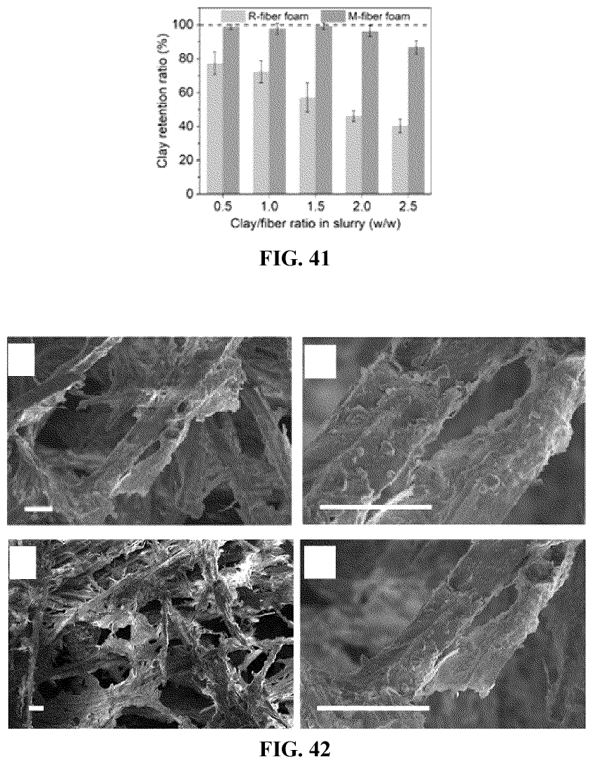

Both R- and M-fibers were subjected to foam laying and air-drying, yielding dry (solid) foams. In comparison, the foam made from M-fiber (FIG. 38) exhibited more intensive inter-fibril interactions than that made from R-fiber (FIG. 39), while not wishing to be limited by theory, which can be attributed to the effect of fibrillation. Preliminary investigation of the clay-fiber interactions was carried out using a kaolinite clay retention test. The stronger and more stable interactions between clay and fibers will lead to a greater clay retention within the fiber network. As presented in FIG. 40, the size of kaolinite clays was found to mostly fall between 2.2 and 25.1 μm (D₂₀ and D₈₀, respectively), with D₅₀ of 5.7 μm. The dry foam made from R-fiber retained 77.3% clay at a clay/fiber ratio of 0.5 (by weight: FIG. 41), which continuously decreased to 40.4% with the increased clay/fiber ratio of up to 2.5. In contrast, the foam prepared using M-fiber showed considerably greater clay retention. Most of the clay remained in the M-fiber foam, with no significant losses after drying at a clay/fiber ratio≤2: note that a clay retention of 86.7% was measured at a clay/fiber ratio of 2.5.

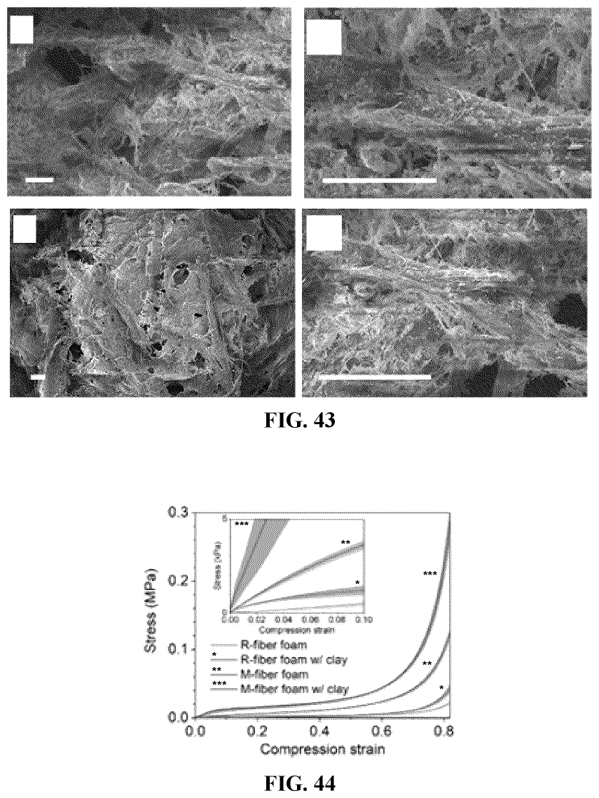

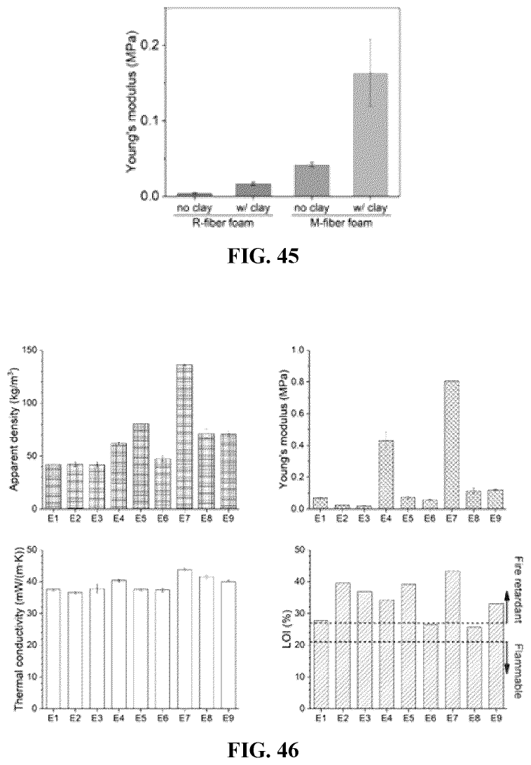

A correlation between clay and wood fibers was provided by electron microscopy images, and an initial clay/fiber ratio of 2 was used to prepare the clay-loaded foams. As shown in FIG. 42 and FIG. 43, particles of sizes in the range of several to tens of micrometers were deposited at the fiber's surfaces. These particles corresponded to clay since they were not observed in foams prepared solely with fibers (FIG. 38 and FIG. 39). Clearly, M-fiber foams held more effectively the clay particles within the fiber network compared to the R-fiber foam (half the value in the latter case, FIG. 41). The hierarchical, hairy structures and the higher surface area greatly enhanced clay particle retention. The R- or M-fiber foams modified with clay displayed higher resistance to compression (FIG. 44) and Young's modulus (FIG. 45) compared to the clay-free counterparts. The M-fiber foams presented a better mechanical resistance compared with the R-fiber ones, while not wishing to be limited by theory, most likely as a result of more robust assembly and higher clay loading in the former foam type. The better inter-fibril interaction and greater clay holding capacity of the M-fiber foams prompted us to conduct the following experiments with these foams.
b) Impact of processing parameters on lignocellulose/clay composite foam properties: Building thermal insulation materials demand thermal insulation (as measured by the thermal conductivity. K), fire retardancy (LOI index), and mechanical strength (represented by Young's modulus, E). Insight into the relative dependence of these performance indicators on foam's apparent density (ρₐ), as a function of M-fiber concentration, surfactant and clay loading, was investigated using the Taguchi method (Antony & Kaye, 2000) (Taguchi-L₉ design, Table 2, with impact on performance indicators summarized in FIG. 46). The S/N ratios were calculated to reveal the sensitivity of the performance indicator to the noise factors, reflecting both the average and variation trend (Antony & Kaye, 2000).

As summarized in the main effect plots, ρₐ is positively correlated with the initial fiber content and clay dosage (FIG. 47, upper left and Table 3) and shows negative correlation with surfactant amount. A foam of higher ρₐ, due to either more intensive densification of wood fibers or greater clay dosage, exhibited greater mechanical robustness under compression, which explained the similar trends of ρₐ and E with respect to the processing parameters (FIG. 47, upper right). In contrast, the denser foam due to higher volumetric proportion of wood fiber or clay raised the heat transfer via solid conduction, resulting in greater K (larger absolute value in FIG. 47, lower left). In addition, the foam's fire retardancy is predominantly governed by clay dosage among others, which agrees with the shielding and inhibiting effect of clay minerals in fire control (FIG. 47, lower right). A detailed discussion of how these processing parameters impacted foam's performance indicators is given below.

TABLE 3
Response table for S/N ratios.

| | | Wood fiber | Surfactant | Clay/wood |
|---|---|---|---|---|
| Performance | Level of | concentration | dosage | fiber mass |
| function | variation | (wt %) | (g/L) | ratio (w/w) |
| ρₐ | 1 | 32.5 | 37.0 | 34.3 |
| (kg/m³) | 2 | 35.8 | 35.9 | 35.2 |
| | 3 | 38.9 | 34.3 | 37.7 |
| | Delta^{a} | 6.4 | 2.7 | 3.4 |
| | Rank^{b} | 1 | 3 | 2 |
| E | 1 | 30.1 | 49.2 | 37.7 |
| (MPa) | 2 | 41.7 | 35.3 | 40.6 |
| | 3 | 46.9 | 34.2 | 40.5 |
| | Delta^{a} | 16.8 | 15.0 | 2.9 |
| | Rank^{b} | 1 | 2 | 3 |
| K | 1 | −31.4 | −32.2 | −31.8 |
| (mW/(m · K)) | 2 | −31.7 | −31.7 | −31.8 |
| | 3 | −32.4 | −31.7 | −32.0 |
| | Delta^{a} | 1.0 | 0.5 | 0.2 |
| | Rank^{b} | 1 | 2 | 3 |
| LOI | 1 | 30.7 | 30.8 | 28.5 |
| (%) | 2 | 30.3 | 30.7 | 31.0 |
| | 3 | 30.5 | 30.1 | 32.0 |
| | Delta^{a} | 0.4 | 0.7 | 3.5 |
| | Rank^{b} | 3 | 2 | 1 |

^{a}Delta refers to the widest variation within a group.
^{b}Rank of delta in the order from high to low.

Based on the dependence of performance indicators on the three processing parameters, the highest and lowest E, K, and LOI were predicted using Taguchi's method (Antony & Kaye, 2000) and the results are summarized in Table 4, as well as the sets of processing parameters that correspond to them. Meanwhile, the experimental results of new foams prepared using these sets of processing parameters were measured, which showed good agreement with their predicted counterparts. Detailed discussion is provided below. This validated the Taguchi method-based formulation optimization. For building insulation, the lignocellulose/clay composite foams are expected to perform properly provided a highest E, highest LOI, and lowest K are achieved, Hence, the following set of conditions was considered as an optimum formulation: fiber content of 5 wt %, surfactant dosage of 1 g/L, and clay/fiber ratio of 2. Though this set of parameters did not lead to the most favored thermal insulation, the variation of K across all the test samples was relatively small (maxima and minima of 43.7 and 36.2 mW/(m·K), respectively), suggesting that one can afford a trade-off in thermal insulation.

TABLE 4
Predicted and experimental results of the highest and lowest performance
function values and the corresponding processing conditions.

| | Highest | M-fiber | Surfactant | Clay/fiber | | | | |
|---|---|---|---|---|---|---|---|---|
| Performance | or | content | dosage | mass ratio | Value of performance function | | | |
| function | lowest* | (wt %) | (g/L) | (w/w) | Predicted | | Experimental | |
| ρₐ | Max | 5 | 1 | 2 | 127 | kg/m³ | 136 ± 1 | kg/m³ |
| | Min | 3 | 3 | 1 | 16.8 | kg/m³ | 19.7 ± 2.1 | kg/m³ |
| E | Max | 5 | 1 | 2 | 0.700 | MPa | 0.805 ± 0.158 | MPa |
| | Min | 3 | 3 | 1 | 0.023 | MPa | 0.023 ± 0.001 | MPa |
| K | Max | 5 | 1 | 2 | 43.7 | mW/(m · K) | 43.7 ± 0.7 | mW/(m · K) |
| | Min | 3 | 3 | 1 | 36.2 | mW/(m · K) | 36.4 ± 0.4 | mW/(m · K) |

| | | | | | | |
|---|---|---|---|---|---|---|
| LOI | Max | 3 | 1 | 2 | 41.6% | 43.6% |
| | Min | 4 | 3 | 1 | 24.0% | 24.6% |

*Max—maxima; Min—minima

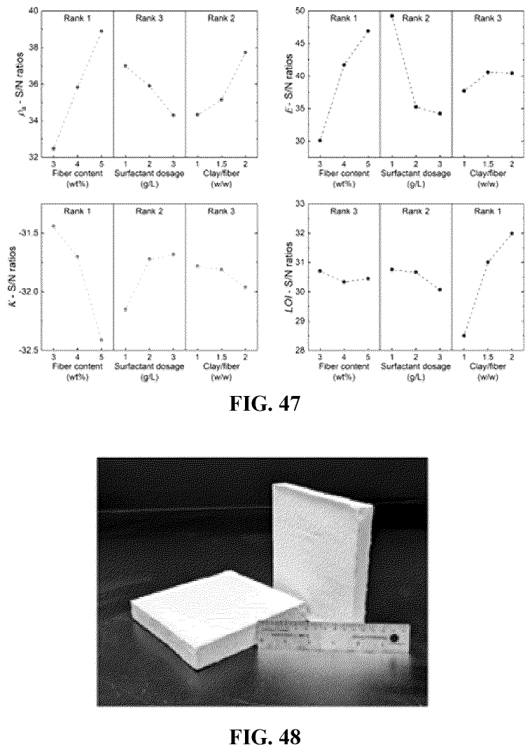

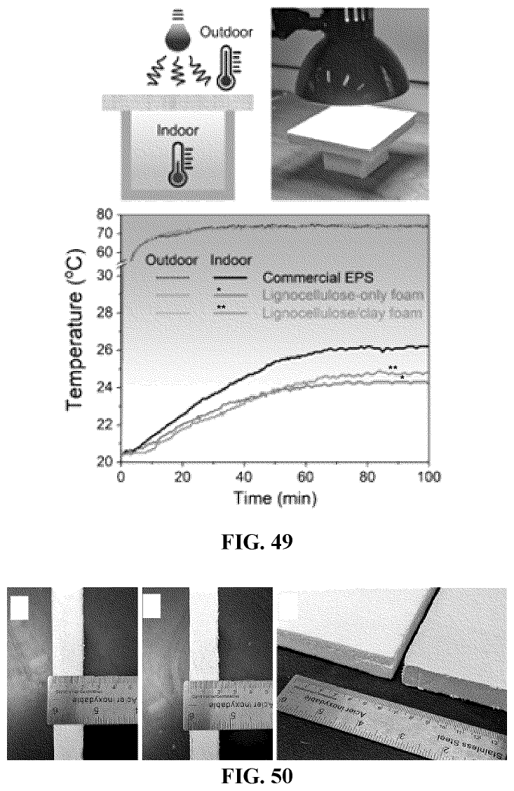

c) Thermal insulation, fire retardancy, and recyclability: The lignocellulose/clay composite foams prepared with the optimum formulation (FIG. 48) were demonstrated for the thermal insulation and fire retardancy performance. Serving as the ceiling for a model house (FIG. 49, upper), the composite foam's insulation behavior was evaluated by examining how the indoor temperature responded to outdoor heating (i.e., high-power incandescent lamp) over time. The respective M-fiber foam and a commercially available EPS foam (thickness kept at 1.9 cm for all samples, FIG. 50) were used as reference. The outdoor temperature increased rapidly, above 60° C. within 5 min, and plateau at around 73° C. after 30 min (FIG. 49, lower). The ceiling's insulation mitigated heat transfer. Specifically, the lignocellulose/clay composite foam allowed an increased indoor temperature of only 4.3° C. within about 70 min. The clay-free foam presented a better insulative capacity (temperature increase of 3.9° C. within 60 min and plateau thereafter) (FIG. 49, lower), which is explained by higher thermal conductivity of clay relative to that of the fibers. Most significantly, the commercial EPS showed a lower insulation capacity compared to the fiber foams (5.7° C. temperature increase within 70 min).

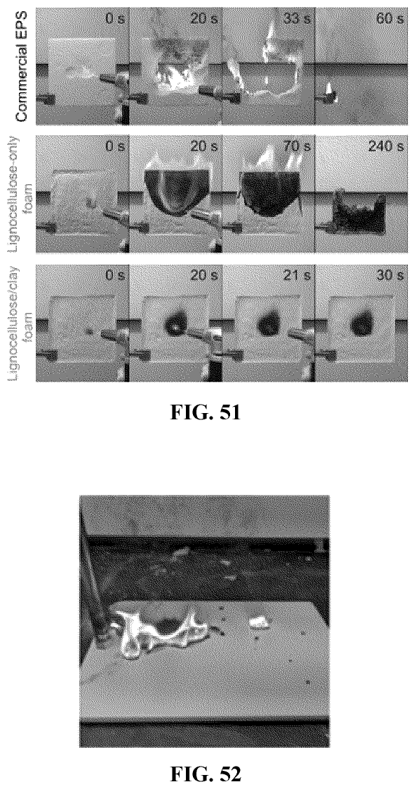

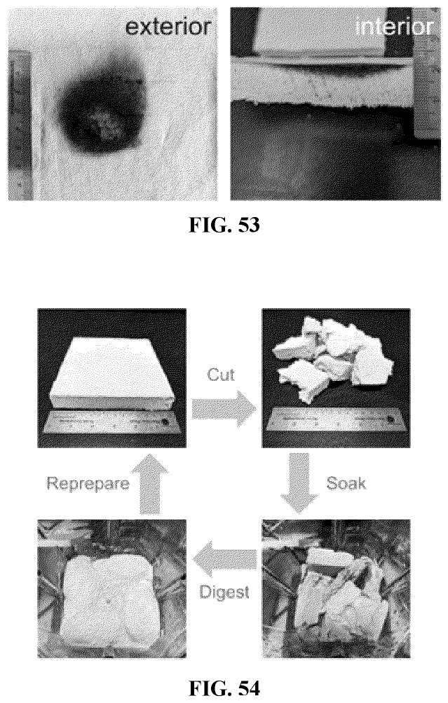

Foams' fire retardancy was demonstrated by igniting a rectangular foam sample using a butane torch (FIG. 51). For commercial EPS, the region in direct contact with the visible flame quickly shrank and ignited, followed by fire spreading to the whole sample. Profusive dark black smoke was observed from the flame, associated with irritating and toxic compounds (Fard & Alkhansari, 2021: Zhao et al., 2022). Moreover, molten EPS droplets dripped from the foam during burning (FIG. 52). Such melting-dripping phenomenon is associated with fire spreading, a major safety concern of most synthetic materials (Liu et al., 2021). Due to rapid burning, most of the EPS sample was combusted within 60 s after ignition. By contrast, the wood fiber generated substantially reduced smoke, with no melting-dripping. Remarkably, the lignocellulose/clay composite foam showed fire resistance. No flame was apparent on the composite foam. Only the region that was directly exposed to flame became charred, while surrounding areas remained unaffected, with no or negligible smoke generation. Importantly, as soon as the source flame was removed (after 20 s), no further apparent damage was observed on the foam. The exterior and cross-section views of the composite foam's charred region is shown in FIG. 53, indicating that a thin charred region (maximum depth of 4 mm) provided satisfactory fire retardancy. Such charred region was relatively strong and stayed as integral parts during cutting (FIG. 53), distinctive from the weak and brittle structure of the burnt wood fiber foam.

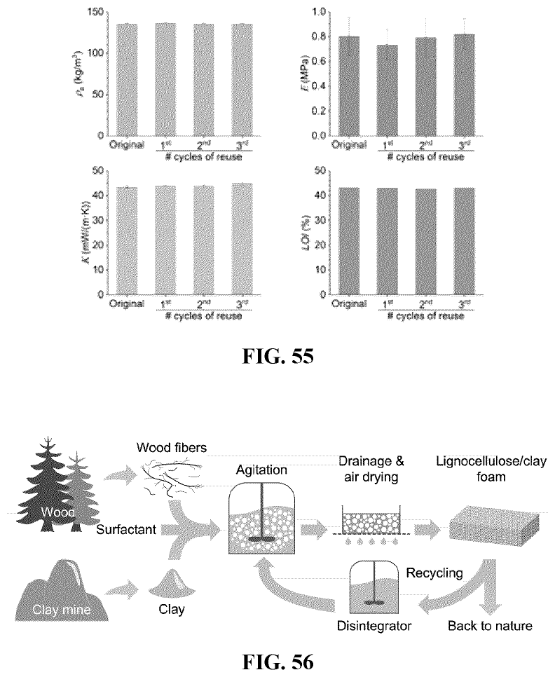

The absence of chemical binders opens the opportunity for foam recycling. As illustrated in FIG. 54, used foams were cut into small pieces, soaked in water to allow sufficient hydration and dispersion into a slurry to prepare a new foam. No statistical difference was observed as far as the performance of reconstituted foam (FIG. 55) after three recycling cycles. It is expected that at the end of the service life after a given number of cycles, the components of the foams can be safely disposed of with no environmental impact.

### d) Impact of Processing Parameters (Fiber Content, Surfactant Amount, and Clay Dosage) on ρₐ, E, K, and LOI of Dried Foam:

ρₐ and E: more intensive fiber entanglement, as a result of higher fiber content in the initial slurry, promoted densification of the foam upon water drainage and drying, leading to a higher ρₐ and E. The incorporated clay stayed embedded in the fiber matrix as an additive. Since it remarkedly increased the foam's total mass but less obviously changed its volume, this led to greater ρₐ as well as greater mechanical robustness (E). By contrast, adding more surfactant amount resulted in production of a larger volume of the wet foam and hence the corresponding dried foam, accounting for a lower ρₐ and E.

K: denser foam with higher volumetric proportion of wood fiber (due to either increasing the fiber content or reducing the surfactant amount) and the embedment of clay in the fiber matrix increased the heat transfer via solid conduction, which resulted in greater K.

LOI: A strong positive correlation was found between the amount of clay loading and the dry foam's fire retardancy, evidently suggesting the fire retardancy was significantly contributed by the clay minerals. In contrast, fiber content played no significant role in fire retardancy, which relates to the presence of air (e.g., oxidizing gas) in the foam. Decreasing surfactant amount led to entrapment of less air in the foam, leading to superior fire resistance as reflected by a lightly increased LOI.
e) Validation of the optimum formulation: Based on FIG. 47 and Table 3, it is straightforward to identify the processing parameters for foams with the highest or lowest pa, E, LOI, and K. For instance, the foam with highest LOI is expected to be prepared with a set of processing parameters that individually correspond to the highest S/N ratio in the LOI's main effect plot (FIG. 47, lower right), i.e., fiber content of 3 wt %, surfactant dosage of 1 g/L, and clay/fiber mass ratio of 2. The highest and lowest E, K, and LOI predicted are summarized in Table 4, as well as the corresponding sets of processing parameters. Meanwhile, the E, K, and LOI of new foams prepared using these sets of processing parameters were measured for comparison with their predicted values. It was observed that the experimental data were in good agreement with their predicted counterparts (Table 4). This validated the Taguchi method-based formulation optimization.

### III. Further Discussion

A scalable strategy was introduced to prepare recyclable, binder-free, fire-retardant lignocellulose/clay composite foams formed by wet foaming followed by oven drying. Pressurized disc milling was effective to fibrillate the coarse wood fibers and introduce hairy structures. Such microfibrillated fibers sustained up to twice the kaolinite weight on the foams, with no need for chemical binding. The optimum lignocellulose/clay composite foams had an apparent density of 136±1 kg/m³, good mechanical strength (E of 0.805±0.158 MPa), satisfactory thermal insulation (K of 43.7±0.7 mW/(m·K)), and fire retardancy (LOI of 43.4%). Direct exposure to butane torch flames (central temperature of 1,430° C.) for 20 s led to the formation of up to 4 mm charred region in the lignocellulose/clay composite foam, which served as a protective layer for the materials underneath. In addition, the absence of chemical binder facilitated recycling of used foams, with no significant deterioration of the performance over three cycles. Taken together, the lignocellulose/clay composite foam may, for example, be useful as a type of sustainable, safe-to-use building thermal insulation with considerable environmental premiums. Overall, this work suggests a cost-effective, scalable technology to develop reusable, binder-free lignocellulose/clay composite foams for insulative applications. For example, FIG. 56 is a schematic showing an exemplary production of lignocellulose/clay composite foam from wood and mineral resources, its recycling and end-of-life disposal. Referring to FIG. 56, wood fibers from wood, clay from a clay mine and surfactant are agitated to obtain a wet foam that, subsequent to drainage and air drying produces a lignocellulose/clay foam which may be degraded (“back to nature”) and/or recycled, for example, via use of a disintegrator followed by production of a recycled wet foam which, subsequent to drainage and air drying produces a recycled lignocellulose/clay foam.

### Example 3: Production of Lignocellulosic Foam Using Alternative Surfactants

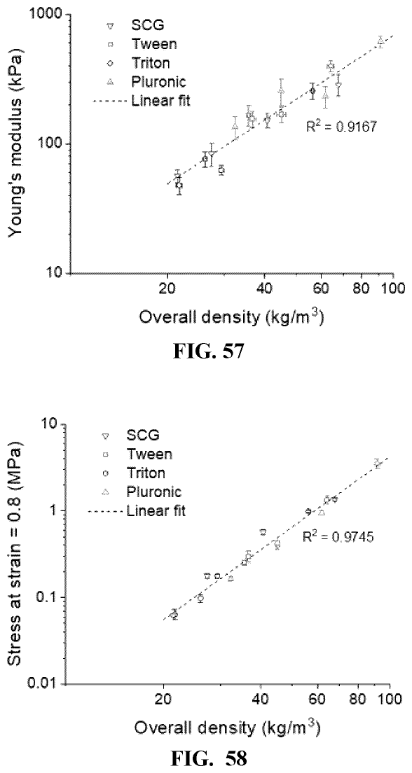

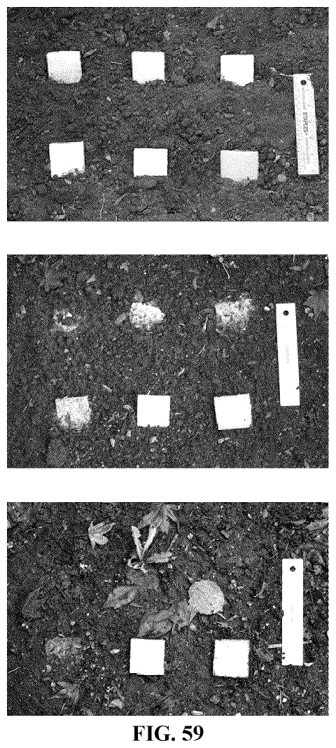

Surfactants from the Detergents Ingredients Database, version 2016 were screened to identify surfactants having lower acute toxicity, lower chronic toxicity and higher degradation potential. Sodium cocoyl glutamate, Tween™ 20, Triton™ X 100 and Pluronic™ 127 were selected as examples and lignocellulosic foams were made from MF-CTMP with these surfactants using a similar preparation method as described in Example 1. FIG. 57 is a plot showing Young's modulus and FIG. 58 is a plot showing stress at strain for exemplary lignocellulosic foams prepared using various dosages (in the range of 0.5-4 g/L, depending on type of surfactant) of these surfactants. After four months, exemplary foams prepared from such surfactants substantially degraded in comparison to exemplary plastic foams, which were observed to have little degradation (FIG. 59). Referring to FIG. 59, from left to right in the top row of each image, lignocellulosic foams prepared using: SCG (1 g/L), Tween-20 (1 g/L) and Triton X-100 (1 g/L); and from left to right in the bottom row of each image: lignocellulosic foam prepared using Pluronic-F127 (1 g/L), expanded polystyrene (EPS), and expanded polyethylene (EPE).

### Example 4: Lignocellulose/Organic Fire-Retardant Composite Foams

Foams were made from MF-CTMP as the woody material, sodium cocoyl glutamate (SCG) as the surfactant and polyethyleneimine (PEI) and phytic acid (PA) as organic fire-retardant materials using the formulations in Table 5 using a method similar to that described in Example 1 to prepare lignocellulosic composite foams.

TABLE 5
Composite formulations.

| Code | PEI (g) | PA (g) | Remaining Ingredients |
|---|---|---|---|
| SA-0 | 0 | 0 | 12 g MF-CTMP |
| SA-1 | 2 | 2 | 1.5 g SCG |
| SA-2 | 4 | 4 | Balance: water to obtain 400 g in total. |
| SA-3 | 6 | 6 | |
| SA-4 | 8 | 8 | |

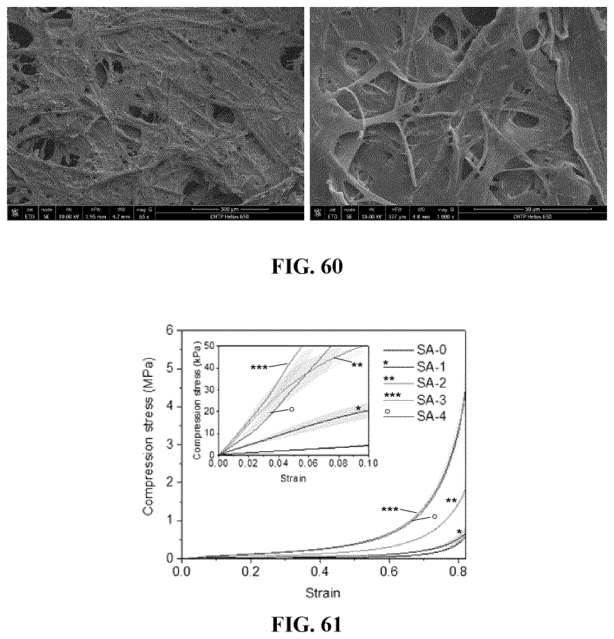

Microstructure: FIG. 60 shows exemplary SEM images of exemplary MF-CTMP/PEI/PA board. In the composite, PEI and PA are embedded in situ within the CTMP scaffold, which promotes inter-fiber entanglement (and adhesion).

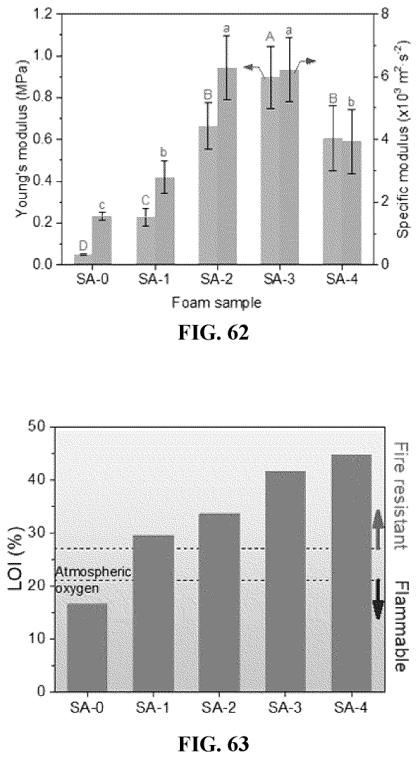

Mechanical properties: FIG. 61 shows a plot of compression stress and FIG. 62 is a plot showing Young's and specific modulus for the formulations. The maxima was achieved for Young's modulus and specific modulus by Sample SA-3. While not wishing to be limited by theory, the reduced performance of SA-4 may be because PEI/PA became the dominant component that weakened the mechanical interactions between MF-CTMP fibers.

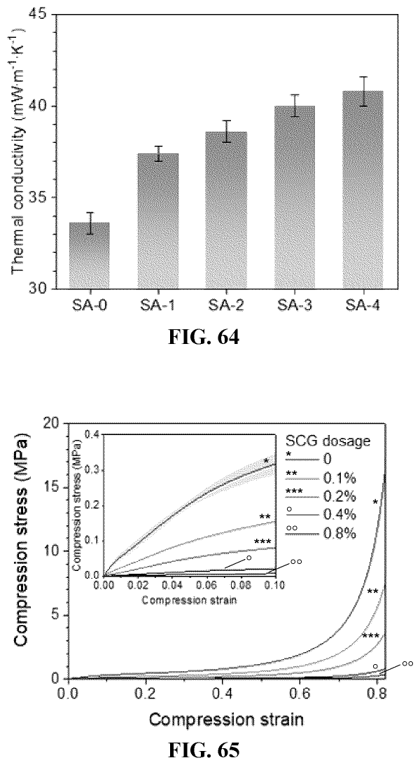

Fire resistance and thermal insulation: Addition of the organic fire retardants substantially improved fire resistance (FIG. 63), with limiting oxygen level (LOI) increasing from 16.5% (for pristine MF-CTMP foam) to 29.5-44.6% (for PEI/PA/MF-CTMP foams). Thermal insulation (FIG. 64) was in the range of 33.6 to 40.8 mW/(m·K), comparable to that of commercial glass fiber mat and polymer foam for building thermal insulation.

### Example 5: Lignocellulose Foams Prepared Using Microfibrillated Sawdust

Foams were made from MF-sawdust as the woody material and sodium cocoyl glutamate (SCG) in varying amounts using the formulations in Table 6 using a method similar to that described in Example 1 to prepare lignocellulosic foams.

TABLE 6
Microfibrillated sawdust formulations.

| SCG (g) | SCG dosage (%) | Remaining Ingredients |
|---|---|---|
| 0 | 0 | 24 g MF-sawdust |
| 0.4 | 0.1 | Balance: water to obtain 400 g in total. |
| 0.8 | 0.2 | |
| 1.6 | 0.4 | |
| 3.2 | 0.8 | |

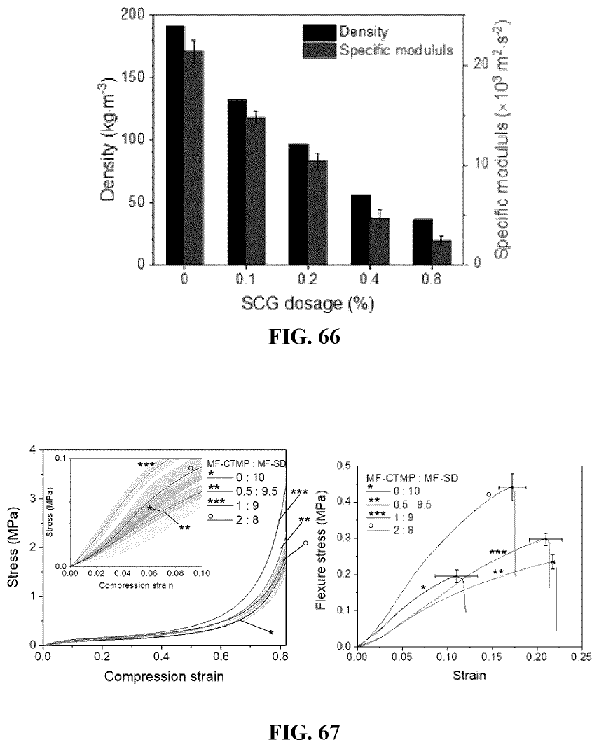

The low aspect ratio of MF-sawdust allowed for a higher amount of biomass in the wet foam (e.g., 6%) than that of MF-CTMP (e.g., 3% as described in Example 1). The foam properties, e.g., compression (FIG. 65), density (FIG. 66) and modulus (FIG. 66) were easily tuned by foaming agent dosage. A SCG dosage of 0.2% was used in the blends discussed below due to its favorable density (about 100 kg/m³) for MF-CTMP foams.

Foams were made from blends of MF-CTMP and MF-sawdust as the woody material and sodium cocoyl glutamate (SCG) in varying amounts using the formulations in Table 7 using a method similar to that described in Example 1 to prepare lignocellulosic foams.

TABLE 7
Microfibrillated sawdust/MF-CTMP blend formulations.

| MF-CTMP:MF-sawdust | |
|---|---|
| (mass ratio) | Remaining Ingredients |
| 0:10 | 24 g of total woody materials |
| 0.5:9.5 | (MF-CTMP + MF-sawdust) |
| 1:9 | 0.8 g SCG |
| 2:8 | Balance: water to obtain 400 g in total. |

MF-CTMP has a higher aspect ratio than that of MF-sawdust and its addition strengthened the foams in comparison to MF-sawdust as the woody material. For example, improved 3-point bending performance was observed with addition of MF-CTMP (FIG. 67).

While the present disclosure has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

### FULL CITATIONS FOR REFERENCES REFERRED TO IN THE DESCRIPTION

Abu-Jdayil, B.; Mourad, A.-H.: Hittini, W.: Hassan, M.; Hameedi, S., Traditional, state-of-the-art and renewable thermal building insulation materials: An overview. Construction and Building Materials 2019, 214, 709-735.
Adamczyk, J.: Dylewski, R., The impact of thermal insulation investments on sustainability in the construction sector. Renewable and Sustainable Energy Reviews 2017, 80, 421-429.
Ahmadzadeh, S.; Nasirpour, A.; Keramat, J.: Hamdami, N.: Behzad, T.: Desobry, S., Nanoporous cellulose nanocomposite foams as high insulated food packaging materials. Colloids and Surfaces A: Physicochemical and Engineering Aspects 2015, 468, 201-210.
Antony, J.: Kaye, M., Analysis and Interpretation of Data from Taguchi Experiments. Springer: Boston, MA, USA, 2000; p 151-193.
ASTM Standard C206, 2022, Standard Specification for Cellulosic Fiber Insulating Board. ASTM International, West Conshohcken, PA, USA.
Beluns, S.: Gaidukovs, S.: Platnieks, O.: Gaidukova, G.; Mierina, I.; Grase, L.: Starkova, O.: Brazdausks, P.: Thakur, V. K., From wood and hemp biomass wastes to sustainable nanocellulose foams. Industrial Crops and Products 2021, 170, 113780.
Bergström, P.: Kolseth, P. In Compression and expansion of CTMP-containing sheets in a wet press nip, Fundamentals of Papermaking, Transactions of the Ninth Fundamental Research Symposium, Cambridge, England, 1989: p 625.
Brazilian Ministry of Agriculture Livestock and Supply Carnaúba., R. técnico de identidade e de qualidade para a classificação da cera de (gabinete do ministro instrução normativa no 34); Brazil, 2004.
Cervin, N. T.: Johansson, E.; Benjamins, J.-W.: Wagberg, L., Mechanisms behind the stabilizing action of cellulose nanofibrils in wet-stable cellulose foams. Biomacromolecules 2015, 16 (3), 822-831.
Chen, R.: Congress, S. S. C.; Cai, G.; Duan, W.: Liu, S., Sustainable utilization of biomass waste-rice husk ash as a new solidified material of soil in geotechnical engineering: A review. Construction and Building Materials 2021, 292, 123219.
Chen, L.: Wang, S.; Wang, S.; Chen, C.; Qi, L.: Yu, L.: Lu, Z.: Huang, J.: Chen, J.: Wang, Z., Scalable Production of Biodegradable, Recyclable, Sustainable Cellulose-Mineral Foams via Coordination Interaction Assisted Ambient Drying. ACS nano 2022, 16 (10), 16414-16425.
Chhajed, M.: Yadav, C.: Agrawal, A. K.; Maji, P. K., Esterified superhydrophobic nanofibrillated cellulose based aerogel for oil spill treatment. Carbohydrate polymers 2019, 226, 115286.
Darpentigny, C.: Nonglaton, G.: Bras, J.: Jean, B., Highly absorbent cellulose nanofibrils aerogels prepared by supercritical drying. Carbohydrate polymers 2020, 229, 115560.
Drenckhan, W.: Saint-Jalmes, A., The science of foaming. Advances in Colloid and Interface Science 2015, 222, 228-259.
EFSA Panel on Food Additives and Nutrient Sources added to Food, Scientific Opinion on the re-evaluation of carnauba wax (E 903) as a food additive. EFSA Journal 2012, 10 (10), 2880.
Fard, P. M.; Alkhansari, M. G., Innovative fire and water insulation foam using recycled plastic bags and expanded polystyrene (EPS). Construction and Building Materials 2021, 305, 124785.
Ferreira, E. S.: Cranston, E. D.; Rezende, C. A., Naturally hydrophobic foams from lignocellulosic fibers prepared by oven-drying. ACS sustainable chemistry & engineering 2020, 8 (22), 8267-8278.
Fortune Business Insights, Building Thermal Insulation Market Size, Share & COVID-19 Impact Analysis, https://www.fortunebusinessinsights.com/building-thermal-insulation-market-102708. 2022.
de Freitas, C. A. S.: de Sousa, P. H. M.: Soares, D. J.; da Silva, J. Y. G.; Benjamin, S. R.; Guedes, M. I. F., Carnauba wax uses in food-A review. Food chemistry 2019, 291, 38-48.
Global Market Insights Building Thermal Insulation Market Size By Material (https: www.gminsights.com industry-analysis building-thermal-insulation-market); Selbyville, DE, USA, 2022.
Gonzalez, R. W.: Jameel, H.; Chang, H.-m.: Treasure, T.; Pirraglia, A.; Saloni, D., Thermo-mechanical pulping as a pretreatment for agricultural biomass for biochemical conversion. BioResources 2011, 6 (2), 1599-1614.
Gu, F.: Wang, W.: Cai, Z.: Xue, F.: Jin, Y.: Zhu, J., Water retention value for characterizing fibrillation degree of cellulosic fibers at micro and nanometer scales. Cellulose 2018, 25 (5), 2861-2871.
Gupta, P.: Singh, B.: Agrawal, A. K.: Maji, P. K., Low density and high strength nanofibrillated cellulose aerogel for thermal insulation application. Materials & Design 2018, 158, 224-236.
Hafez, I.: Tajvidi, M., Comprehensive Insight into Foams Made of Thermomechanical Pulp Fibers and Cellulose Nanofibrils via Microwave Radiation. ACS Sustainable Chemistry & Engineering 2021, 9 (30), 10113-10122.
He, S.: Liu, C.: Chi, X.: Zhang, Y.: Yu, G.: Wang, H.: Li, B.: Peng, H., Bio-inspired lightweight pulp foams with improved mechanical property and flame retardancy via borate cross-linking. Chemical Engineering Journal 2019, 371, 34-42.
He, Z.: Han, X.: Zhang, Y.: Zhang, Z.: Shi, J.: Gencel, O., Development of a new magnesium oxychloride cement board by recycling of waste wood, rice husk ash and flue gas desulfurization gypsum. Journal of Building Engineering 2022, 61, 105206.
Hong, J.: Wu, T.: Wu, H.: Zeng, B.: Zeng, S.: Chen, T.: Wang, X.: Lu, Z.: Yuan, C.; Balaji, K., Nanohybrid silver nanoparticles@ halloysite nanotubes coated with polyphosphazene for effectively enhancing the fire safety of epoxy resin. Chemical Engineering Journal 2021, 407, 127087.
Hou, Y.: Xu, Z.: Chu, F.: Gui, Z.: Song, L.: Hu, Y.: Hu, W., A review on metal-organic hybrids as flame retardants for enhancing fire safety of polymer composites. Composites Part B: Engineering 2021, 221, 109014.
Huang, Y.: Jiang, S.; Liang, R.: Liao, Z.: You, G., A green highly-effective surface flame-retardant strategy for rigid polyurethane foam: Transforming UV-cured coating into intumescent self-extinguishing layer. Composites Part A: Applied Science and Manufacturing 2019, 125, 105534.
Hurtado, P. L.: Rouilly, A.; Vandenbossche, V.; Raynaud, C., A review on the properties of cellulose fibre insulation. Building and environment 2016, 96, 170-177.
Jahangiri, P.: Korehei, R.: Zeinoddini, S. S.: Madani, A.; Sharma, Y.: Phillion, A.; Martinez, D. M.: Olson, J. A., On filtration and heat insulation properties of foam formed cellulose based materials. Nordic Pulp & Paper Research Journal 2014, 29 (4), 584-591.
Jia, Y.-W.: Zhao, X.: Fu, T.; Li, D.-F.: Guo, Y.: Wang, X.-L.: Wang, Y.-Z., Synergy effect between quaternary phosphonium ionic liquid and ammonium polyphosphate toward flame retardant PLA with improved toughness. Composites Part B: Engineering 2020, 197, 108192.
Jiang, F.: Hsieh, Y.-L., Cellulose nanofibril aerogels: synergistic improvement of hydrophobicity, strength, and thermal stability via cross-linking with diisocyanate. ACS applied materials & interfaces 2017, 9 (3), 2825-2834.
Jiang, S.: Zhang, M.: Li, M.: Zhu, J.: Ge, A.; Liu, L.: Yu, J., Cellulose-based composite thermal-insulating foams toward eco-friendly, flexible and flame-retardant. Carbohydrate Polymers 2021, 273, 118544.
Jiménez-Saelices, C.: Seantier, B.: Cathala, B.: Grohens, Y., Spray freeze-dried nanofibrillated cellulose aerogels with thermal superinsulating properties. Carbohydrate polymers 2017, 157, 105-113.
Jiménez-Saelices, C.: Seantier, B.; Grohens, Y.: Capron, I., Thermal superinsulating materials made from nanofibrillated cellulose-stabilized pickering emulsions. ACS applied materials & interfaces 2018, 10 (18), 16193-16202.
Karadagli, I.: Schulz, B.: Schestakow, M.: Milow, B.: Gries, T.: Ratke, L., Production of porous cellulose aerogel fibers by an extrusion process. The Journal of Supercritical Fluids 2015, 106, 105-114.
Kobayashi, Y.: Saito, T.: Isogai, A., Aerogels with 3D ordered nanofiber skeletons of liquid-crystalline nanocellulose derivatives as tough and transparent insulators. Angewandte Chemie 2014, 126 (39), 10562-10565.
Kumari, S.: Chauhan, G. S.; Ahn, J. H., Novel cellulose nanowhiskers-based polyurethane foam for rapid and persistent removal of methylene blue from its aqueous solutions. Chemical Engineering Journal 2016, 304, 728-736.
Li, S. C.: Hu, B. C.: Ding, Y. W.: Liang, H. W.; Li, C.: Yu, Z. Y.: Wu, Z. Y.; Chen, W. S.; Yu, S. H., Wood-derived ultrathin carbon nanofiber aerogels. Angewandte Chemie International Edition 2018, 57 (24), 7085-7090.
Li, M.-E.: Yan, Y.-W.: Zhao, H.-B.; Jian, R.-K.: Wang, Y.-Z., A facile and efficient flame-retardant and smoke-suppressant resin coating for expanded polystyrene foams. Composites Part B: Engineering 2020, 185, 107797.
Li, J.: Lu, Z.: Xie, F.; Huang, J.: Ning, D.: Zhang, M., Highly compressible, heat-insulating and self-extinguishing cellulose nanofiber/aramid nanofiber nanocomposite foams. Carbohydrate Polymers 2021, 261, 117837.
Li, J.: Tian, J.: Gao, Y.; Qin, R.: Pi, H.: Li, M.: Yang, P., All-natural superhydrophobic coating for packaging and blood-repelling materials. Chemical Engineering Journal 2021b, 410, 128347.
Li, T.: Chen, C.: Brozena, A. H.: Zhu, J.: Xu, L.; Driemeier, C.: Dai, J.: Rojas, O. J.: Isogai, A.: Wågberg, L., Developing fibrillated cellulose as a sustainable technological material. Nature 2021c, 590 (7844), 47-56.
Li, Y.: Chen, Y.: He, X.; Xiang, Z.; Heinze, T.: Qi, H., Lignocellulose nanofibril/gelatin/MXene composite aerogel with fire-warning properties for enhanced electromagnetic interference shielding performance. Chemical Engineering Journal 2022, 431, 133907.
Linares, C.: Díaz, J.: Negev, M.: Martinez, G. S.: Debono, R.; Paz, S., Impacts of climate change on the public health of the Mediterranean Basin population-current situation, projections, preparedness and adaptation. Environmental research 2020, 182, 109107.
Liu, Y.: Lu, P.: Xiao, H.; Heydarifard, S.: Wang, S., Novel aqueous spongy foams made of three-dimensionally dispersed wood-fiber: entrapment and stabilization with NFC/MFC within capillary foams. Cellulose 2017, 24 (1), 241-251.
Liu, B.-W.: Zhao, H.-B.; Chen, L.: Chen, L.: Wang, X.-L.: Wang, Y.-Z., Eco-friendly synergistic cross-linking flame-retardant strategy with smoke and melt-dripping suppression for condensation polymers. Composites Part B: Engineering 2021, 211, 108664.
Lohtander, T.: Herrala, R.: Laaksonen, P.; Franssila, S.: Österberg, M., Lightweight lignocellulosic foams for thermal insulation. Cellulose 2022, 1-17.
Malekzadeh, H.: Md Zaid, N.: Bele, E., Characterization and structural properties of bamboo fibre solid foams. Cellulose 2021, 28 (2), 703-714.
Milby, T. H.: Wolf, C. R., Respiratory tract irritation from fibrous glass inhalation. Journal of Occupational and Environmental Medicine 1969, 11 (8), 409-410.
Muthuraj, R.: Lacoste, C.: Lacroix, P.: Bergeret, A., Sustainable thermal insulation biocomposites from rice husk, wheat husk, wood fibers and textile waste fibers: Elaboration and performances evaluation. Industrial Crops and Products 2019, 135, 238-245.
Oudin Aström, D.: Forsberg, B.: Ebi, K. L.: Rocklöv, J., Attributing mortality from extreme temperatures to climate change in Stockholm, Sweden. Nature climate change 2013, 3 (12), 1050-1054.
Pöhler, T.: Jetsu, P.: Fougerón, A.: Barraud, V., Use of papermaking pulps in foam-formed thermal insulation materials. Nordic Pulp & Paper Research Journal 2017, 32 (3), 367-374.
Prakash, R.: Majumder, S. K.: Singh, A., Particle-laden bubble size and its distribution in microstructured bubbling bed in the presence and absence of a surface active agent. Industrial & Engineering Chemistry Research 2019, 58 (8), 3499-3522.
Qin, H.: Zhang, Y.: Jiang, J.: Wang, L.: Song, M.: Bi, R.: Zhu, P.: Jiang, F., Multifunctional Superelastic Cellulose Nanofibrils Aerogel by Dual Ice-Templating Assembly. Advanced Functional Materials 2021, 2106269.
Rehman, Z. U.: Huh, S.-H.: Ullah, Z.: Pan, Y.-T.: Churchill, D. G.; Koo, B. H., LBL generated fire retardant nanocomposites on cotton fabric using cationized starch-clay-nanoparticles matrix. Carbohydrate Polymers 2021, 274, 118626.
Ren, X.: Song, M.: Jiang, J.: Yu, Z.; Zhang, Y.: Zhu, Y.: Xuelei, L.: Li, C.; Oguzlu-Baldelli, H.: Jiang, F., Fire-retardant and thermal insulating cellulose nanofibril aerogel modified by in-situ supramolecular assembly of melamine and phytic acid. Advanced Engineering Materials 2022, 2101534.
Sakai, K.: Kobayashi, Y.: Saito, T.: Isogai, A., Partitioned airs at microscale and nanoscale: thermal diffusivity in ultrahigh porosity solids of nanocellulose. Scientific Reports 2016, 6 (1), 1-7.
Saint-Jalmes, A., Physical chemistry in foam drainage and coarsening. Soft Matter 2006, 2 (10), 836-849.
Sripaiboonkij, P.: Sripaiboonkij, N.: Phanprasit, W.: Jaakkola, M. S., Respiratory and skin health among glass microfiber production workers: a cross-sectional study. Environmental Health 2009, 8 (1), 1-10.
Theng, D.: Arbat, G.: Delgado-Aguilar, M.: Vilaseca, F.: Ngo, B.: Mutje, P., All-lignocellulosic fiberboard from corn biomass and cellulose nanofibers. Industrial Crops and Products 2015, 76, 166-173.
US Coastal Guard, Chemical Hazard Response Information System (CHRIS)-Hazardous Chemical Data. Commandant Instruction 16465-12C. 1999; p 2911.
Villasmil, W.: Fischer, L. J.: Worlitschek, J., A review and evaluation of thermal insulation materials and methods for thermal energy storage systems. Renewable and Sustainable Energy Reviews 2019, 103, 71-84.
Wang, W.: Mozuch, M. D.: Sabo, R. C.; Kersten, P.: Zhu, J.: Jin, Y., Endoglucanase post-milling treatment for producing cellulose nanofibers from bleached Eucalyptus fibers by a supermasscolloider. Cellulose 2016, 23 (3), 1859-1870.
Wang, P.: Aliheidari, N.: Zhang, X.: Ameli, A., Strong ultralight foams based on nanocrystalline cellulose for high-performance insulation. Carbohydrate polymers 2019, 218, 103-111.
West, G. C.: Salo, A. C., Seasonal changes in water and fat content and fatty acid composition of the catkin buds of Alaska willow (Salix alaxensis). Oecologia 1979, 41 (2), 207-218.
Wu, M.: Yu, G.; Chen, W.: Dong, S.: Wang, Y.: Liu, C.: Li, B., A pulp foam with highly improved physical strength, fire-resistance and antibiosis by incorporation of chitosan and CPAM. Carbohydrate Polymers 2022, 278, 118963.
Xiang, W.: Preisig, N.: Ketola, A.; Tardy, B. L.: Bai, L.; Ketoja, J. A.; Stubenrauch, C.; Rojas, O. J., How cellulose nanofibrils affect bulk, surface, and foam properties of anionic surfactant solutions. Biomacromolecules 2019, 20 (12), 4361-4369.
Yang, W.-J.: Wei, C.-X.: Yuen, A. C. Y.: Lin, B.: Yeoh, G. H.: Lu, H.-D.; Yang, W., Fire-retarded nanocomposite aerogels for multifunctional applications: A review. Composites Part B: Engineering 2022, 109866.
Yi, Z.: Zhang, X.; Yan, L.; Huyan, X.; Zhang, T.: Liu, S.: Guo, A.; Liu, J.: Hou, F., Super-insulated, flexible, and high resilient mullite fiber reinforced silica aerogel composites by interfacial modification with nanoscale mullite whisker. Composites Part B: Engineering 2022, 230, 109549.
Zhang, W.: Lu, P.: Qian, L.: Xiao, H., Fabrication of superhydrophobic paper surface via wax mixture coating. Chemical Engineering Journal 2014, 250, 431-436.
Zhang, Y.: Simpson, B. K.: Dumont, M.-J., Effect of beeswax and carnauba wax addition on properties of gelatin films: A comparative study. Food Bioscience 2018, 26, 88-95.
Zhang, Y.: Bai, M.: Zhang, A.: Zhang, X.: Dong, Y.: Kang, H.: Zhang, Q.: Li, J., A facile and small-molecule regulated borate network gelation to improve the mildew proof, fire-retardant of bamboo. Industrial Crops and Products 2023, 197, 116602.
Zhao, H.: Yuan, B.: Zhan, Y.: Yang, F.: Zhou, J.: Qi, C.; Lei, C.: Li, Y., Upgrading the pore-size scale of MIL-53 from microporous to macroporous for adsorbing triethyl phosphate and reducing the fire risk of polystyrene. Composites Part A: Applied Science and Manufacturing 2022, 159, 107003.
Zhao, X.: Liu, Y.: Zhao, L.: Yazdkhasti, A.: Mao, Y.: Siciliano, A. P.; Dai, J.: Jing, S.: Xie, H.: Li, Z., A scalable high-porosity wood for sound absorption and thermal insulation. Nature Sustainability 2023, 1-10.
Zhou, J.: Hsieh, Y.-L., Nanocellulose aerogel-based porous coaxial fibers for thermal insulation. Nano Energy 2020, 68, 104305.
Zhou, S.: Apostolopoulou-Kalkavoura, V.: Tavares da Costa, M. V.: Bergström, L.: Stromme, M.: Xu, C., Elastic aerogels of cellulose nanofibers@ metal-organic frameworks for thermal insulation and fire retardancy. Nano-micro Letters 2020b, 12 (1), 1-13.
Zhu, J.: Zhao, F.; Peng, T.: Liu, H.: Xie, L.; Jiang, C., Highly elastic and robust hydroxyapatite nanowires/polyimide composite aerogel with anisotropic structure for thermal insulation. Composites Part B: Engineering 2021, 223, 109081.
Zhu, Y.: Yu, Z.: Zhu, J.; Zhang, Y.: Ren, X.: Jiang, F., Developing flame-retardant lignocellulosic nanofibrils through reactive deep eutectic solvent treatment for thermal insulation. Chemical Engineering Journal 2022, 136748.

1. A method of preparing a foam, the method comprising:
foaming an aqueous suspension comprising microfibrillated lignocellulose and a foaming agent to obtain a wet foam; and
drying the wet foam to obtain the foam.

2. The method of claim 1, wherein the foaming agent comprises a surfactant.

3. The method of claim 2, wherein the surfactant comprises an anionic surfactant, a non-ionic surfactant or combinations thereof.

4. The method of claim 3, wherein the anionic surfactant comprises a sulfate group, a sulfonate group, a glutamate group or combinations thereof.

5. The method of claim 4, wherein the surfactant is sodium dodecyl sulfate.

6. The method of claim 4, wherein the surfactant is C₁₄-C₁₆ alpha olefin sulfonate.

7. The method of claim 4, wherein the surfactant is sodium cocoyl glutamate.

8. The method of claim 3, wherein the non-ionic surfactant is a polysorbate, an alkylphenyl ether of polyethylene glycol, a poloxamer or combinations thereof.

9. The method of claim 3, wherein the surfactant is sodium cocoyl glutamate, Tween™-20, Triton™ X100 or Pluronic™-127.

10. The method of any one of claims 2 to 9, wherein the dosage of the surfactant in the aqueous suspension is in the range of about 0.2 g/L to about 3.0 g/L.

11. The method of any one of claims 1 to 10, wherein subsequent to drying, the method further comprises applying a hydrophobic coating to obtain the foam.

12. The method of claim 11, wherein the hydrophobic coating comprises wax.

13. The method of claim 12, wherein the wax comprises palm wax.

14. The method of any one of claims 1 to 13, wherein the microfibrillated lignocellulose is obtained by a method comprising mechanical treatment of a lignocellulose source.

15. The method of any one of claims 1 to 14, wherein the microfibrillated lignocellulose comprises microfibrillated softwood chemi-thermomechanical pulp (CTMP), microfibrillated refined softwood wood chips, microfibrillated sawdust or combinations thereof.

16. The method of claim 15, wherein the microfibrillated lignocellulose comprises microfibrillated softwood chemi-thermomechanical pulp (CTMP).

17. The method of any one of claims 1 to 16, wherein the concentration of the microfibrillated lignocellulose in the aqueous suspension is about 0.1 wt % to about 10 wt %.

18. The method of any one of claims 1 to 16, wherein the concentration of the microfibrillated lignocellulose in the aqueous suspension is about 3 wt %.

19. The method of any one of claims 1 to 18, wherein the drying comprises heating.

20. The method of any one of claims 1 to 19, wherein the aqueous suspension further comprises a fire retardant.

21. The method of claim 20, wherein the fire retardant comprises a clay.

22. The method of claim 21, wherein the clay comprises kaolinite.

23. The method of claim 20, wherein the fire retardant comprises a combination of polyethyleneimine (PEI) and phytic acid (PA).

24. The method of any one of claims 1 to 23, wherein the foam does not comprise a binder.

25. A method of preparing a recycled foam, the method comprising:
preparing an aqueous dispersion comprising a foam prepared from a method as defined in claim 24; and
drying the aqueous dispersion to prepare the recycled foam.

26. A foam prepared by a method as defined in any one of claims 1 to 25.

27. A foam comprising microfibrillated lignocellulose.

28. The foam of claim 27, wherein the foam further comprises a hydrophobic coating.

29. The foam of claim 27 or 28, further comprising a fire retardant.

30. The foam of claim 29, wherein the fire retardant comprises clay.

31. The foam of claim 30, wherein the clay comprises kaolinite.

32. The foam of claim 29, wherein the fire retardant comprises a combination of polyethyleneimine (PEI) and phytic acid (PA).

33. The foam of any one of claims 27 to 32, that does not comprise a binder.

34. A use of a foam as defined in any one of claims 26 to 33 in insulation or packaging.
